(19) United States
(12) Patent Application Publication
(10) Pub. No.: US 2025/0289984 A1
(43) Pub. Date: Sep. 18, 2025

(54) ADHESIVE COMPOSITION, ADHESIVE SHEET, ADHESIVE SHEET EQUIPPED WITH MOLD RELEASE FILM, LAMINATE FOR IMAGE DISPLAY DEVICES, IMAGE DISPLAY DEVICE, AND ADHESIVE SHEET FOR ORGANIC EL DISPLAY DEVICES

(71) Applicant: MITSUBISHI CHEMICAL CORPORATION, Tokyo (JP)

(72) Inventors: Daiki NOZAWA, Tokyo (JP); Hisatoshi KURA, Tokyo (JP); Shinya FUKUDA, Tokyo (JP); Satoshi TASHIRO, Tokyo (JP); Sho YAMASHITA, Tokyo (JP); Hitomi FUKASAWA, Tokyo (JP)

(73) Assignee: MITSUBISHI CHEMICAL CORPORATION, Tokyo (JP)

(21) Appl. No.: 19/221,080

(22) Filed: May 28, 2025

Related U.S. Application Data
(63) Continuation of application No. PCT/JP2023/042704, filed on Nov. 29, 2023.

(30) Foreign Application Priority Data
Nov. 30, 2022 (JP) 2022-192160
Nov. 30, 2022 (JP) 2022-192169
Aug. 18, 2023 (JP) 2023-133424

(51) Int. Cl. C09J 151/00; C08K 5/13; C08K 5/3492; C08K 5/37; C09J 7/38

(52) U.S. Cl. CPC C09J 151/006; C08K 5/13; C08K 5/3492; C08K 5/37; C09J 7/385; C09J 2203/326; C09J 2301/408; C09J 2301/416; C09J 2451/00

(57) ABSTRACT

The present disclosure provides an adhesive composition contains a (meth)acrylic polymer (A) and a photoinitiator (B).

### TECHNICAL FIELD

The present invention relates to an adhesive composition, an adhesive sheet using the same, an adhesive sheet equipped with a mold release film, a laminate for image display devices, an image display device, and an adhesive sheet for organic EL display devices.

This application is a continuation application of International Application No. PCT/JP2023/042704, filed on Nov. 29, 2023, which claims the benefit of priority of the prior Japanese Patent Application No. 2022-192169 and Japanese Patent Application No. 2022-192160, filed Nov. 30, 2022, and Japanese Patent Application No. 2023-133424, filed Aug. 18, 2023, the contents of which are incorporated herein by reference.

### BACKGROUND ART

In recent years, in order to improve the visibility of image display devices, a void between an image display panel such as a liquid crystal display (LCD), a plasma display (PDP), and an electroluminescent display (ELD) and an optical member such as a protective panel and a touch panel member, which is disposed on a front surface side (visible side) of the image display panel, is filled with a resin such as a pressure-sensitive adhesive and an adhesive, and reflection of incident light or emitted light from a display image at an air layer interface is suppressed.

For example, Patent Document 1 discloses a method of irradiating an adhesive sheet with ultraviolet rays to perform secondary curing after bonding an adhesive sheet which has been subjected to primary crosslinking with ultraviolet rays to an image display device constituent member, as a manufacturing method of a constituent laminate for image display devices, having a configuration in which the image display device constituent member is laminated on at least one side of the transparent double-sided adhesive sheet.

In addition, Patent Document 2 discloses a pressure-sensitive adhesive sheet containing a (meth)acrylic copolymer having an ultraviolet crosslinkable moiety, as an adhesive sheet useful for a display and a touch panel.

### CITATION LIST

### Patent Documents

Patent Document 1: Japanese Patent No. 4971529
Patent Document 2: Japanese Patent No. 6062740

### SUMMARY OF INVENTION

### Technical Problem

Most of the adhesive sheets which form a crosslinked structure upon ultraviolet irradiation contain a photoinitiator that generates a radical upon ultraviolet irradiation. However, in recent years, from the viewpoint of energy saving and member protection, there has been an increasing demand for an adhesive sheet which is photocured with relatively low energy and high efficiency, that is, an adhesive sheet which is cured by energy rays on a relatively long wavelength side (for example, active energy rays having a wavelength longer than 380 nm), particularly, visible rays.

Furthermore, in recent years, with the demand for power saving, weight reduction, and thinning of image display devices, organic EL has been widely used as an image display panel instead of the liquid crystal panel in the related art.

In an image display device such as an organic EL display device, a constituent member or the like in the image display device may be deteriorated by ultraviolet light, and an adhesive sheet which is cured by visible light is strongly required in order to suppress deterioration due to the ultraviolet light.

In addition, in an adhesive sheet which is bonded to an adherend such as the image display device constituent member and is secondary-cured by irradiating the adhesive sheet with light through the member, when an intervening member has ultraviolet absorbability, there is a problem in that light required for the curing does not reach the adhesive sheet, and the adhesive sheet used in the image display device having such a configuration needs to be an adhesive sheet which is cured with visible light.

In addition, in the image display device such as an organic EL display device, there is an increasing demand for an adhesive sheet containing an ultraviolet absorber in order to suppress deterioration due to incident ultraviolet light.

Most of the adhesive sheets which form a crosslinked structure upon ultraviolet irradiation contain a photoinitiator that generates a radical upon ultraviolet irradiation. However, when the adhesive sheet contains an ultraviolet absorber, there is a problem in that ultraviolet rays are shielded and a curing reaction does not proceed sufficiently.

From these facts, a photocurable adhesive sheet using a photoinitiator having absorption in a longer wavelength ultraviolet range or a visible light range, or an α-aminoacetophenone-based photoinitiator or acylphosphine oxide-based photoinitiator has been developed. However, these cleavage-type photoinitiators generate outgas such as benzaldehyde as a photodecomposition product, which is not preferable from the viewpoint of the environment.

On the other hand, in hydrogen abstraction-type photoinitiators such as a thioxanthone-based photoinitiator and an anthraquinone-based photoinitiator, which do not generate photodecomposition products during the reaction, although the photoinitiator has absorption in the longer wavelength ultraviolet range or the visible light range, there is a problem in that the cured product is colored, particularly yellowed, due to the photoinitiator. Therefore, particularly in applications required to be colorless or transparent, there is a limit to the amount of the additive, and sufficient curing sensitivity cannot be obtained.

One object of the present invention is to provide an adhesive composition having a small amount of photodecomposition products, which can be cured with an energy ray on a relatively long wavelength side, for example, an active energy ray having a wavelength of more than 380 nm, particularly, an active energy ray having a wavelength of 405 nm; an adhesive sheet; and a laminate for image display devices, an image display device, and an adhesive sheet for organic EL display devices, each of which uses the adhesive sheet.

Another object of the present invention is to provide an adhesive composition having a small amount of photodecomposition products, ultraviolet absorbability, and that can be cured by active energy rays; an adhesive sheet; and an adhesive sheet equipped with a mold release film, a laminate for image display devices, an image display device, and an adhesive sheet for organic EL display devices, each of which uses the adhesive sheet.

### Solution to Problem

One embodiment of the present invention includes the following aspects.
[1] An adhesive composition comprising:
a (meth)acrylic polymer (A); and
a photoinitiator (B),
wherein the photoinitiator (B) includes a photoinitiator (b1) having a glyoxylate structure represented by Formula 1 and a molar absorption coefficient at a wavelength of 405 nm of 30 (L/mol·cm) or more,

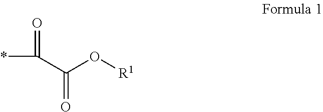

(in Formula 1, R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl, and * represents a bonding site).
[2] An adhesive composition comprising:
a (meth)acrylic polymer (A);
a photoinitiator (B); and
an ultraviolet absorber (C),
wherein the photoinitiator (B) includes a photoinitiator (b1) having a glyoxylate structure represented by Formula 1 and a molar absorption coefficient at a wavelength of 405 nm of 30 (L/mol·cm) or more,

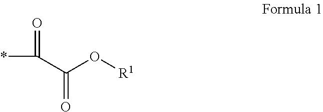

(in Formula 1, R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl, and * represents a bonding site).
[3] The adhesive composition according to [1] or [2], wherein the photoinitiator (b1) is a compound having a biphenyl structure to which the bonding site * in Formula 1 is bonded.
[4] The adhesive composition according to [1] or [2], wherein the photoinitiator (b1) is a compound having a biphenyl sulfide structure to which the bonding site * in Formula 1 is bonded.
[5] The adhesive composition according to any one of [1] to [4], wherein the photoinitiator (b1) is a compound having two or more radical-generating groups in a molecule.
[6] The adhesive composition according to any one of [1] to [5], further comprising:
a polyfunctional (meth)acrylate (D).
[7] The adhesive composition according to [6], wherein the contained amount of the polyfunctional (meth)acrylate (D) is 0.1 parts by mass or more and 20 parts by mass or less with respect to 100 parts by mass of the (meth)acrylic polymer (A).
[8] The adhesive composition according to any one of [1] to [7], wherein the (meth)acrylic polymer (A) includes a constitutional unit derived from an alkyl (meth)acrylate containing a linear or branched alkyl group having 3 to 30 carbon atoms in an alkyl group, and includes a constitutional unit derived from a hydroxyl group-containing monomer and/or a constitutional unit derived from a nitrogen-containing monomer.
[9] An adhesive sheet comprising:
an adhesive layer formed of the adhesive composition according to any one of [1] to [8].
[10] The adhesive sheet according to [9], wherein light transmittance at a wavelength of 380 nm is 10% or less.
[11] The adhesive sheet according to [9] or [10], wherein light transmittance at a wavelength of 400 nm is 30% or less.
[12] The adhesive sheet according to any one of [9] to [11], wherein total light transmittance is 80% or more.
[13] The adhesive sheet according to any one of [9] to [10], wherein a gel fraction (X0) is 20% or more.
[14] The adhesive sheet according to [13],
wherein the adhesive sheet has active energy ray curability, and
a gel fraction (X1) of the adhesive sheet when the adhesive sheet is irradiated with an active energy ray having a wavelength of 405 nm with an integrated light amount of 2,000 to 4,000 mJ/cm² is 30% or more.
[15] The adhesive sheet according to [14],
wherein a difference (X1−X0) between the gel fraction (X1) and the gel fraction (X0) is 2% or more.
[16] The adhesive sheet according to any one of [9] to [15],
wherein the adhesive sheet has active energy ray curability,
a chromaticity (b*1) of the adhesive sheet when the adhesive sheet is irradiated with an active energy ray having a wavelength of 405 nm with an integrated light amount of 2,000 to 4,000 mJ/cm² is 2.5 or less, and a difference (b*1−b*0) between the chromaticity (b*1) and a chromaticity (b*0) before the irradiation with the active energy ray is 1.0 or less.
[17] The adhesive sheet according to any one of [9] to [16], wherein the adhesive sheet is used for bonding an optical member.
[18] An adhesive sheet equipped with a mold release film, comprising:
the adhesive sheet according to any one of [9] to [17]; and
a mold release film which is laminated with the adhesive sheet.
[19]A laminate for image display devices, comprising:
two optical members which are laminated through the adhesive sheet according to any one of [1] to [17].
[20] An image display device, comprising:
the laminate for image display devices according to [19].
[21] An adhesive sheet for organic EL display devices, comprising:
the adhesive sheet according to any one of [9] to [17].
[22] An adhesive sheet comprising:
an adhesive layer formed of an adhesive composition containing a (meth)acrylic polymer (A) and a photoinitiator (B),
wherein the photoinitiator (B) includes a compound represented by Formula 2,

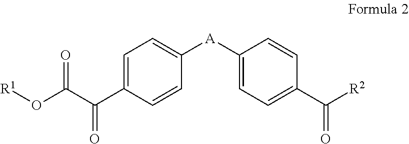

(in Formula 2, A is O, S, NR⁴, or a linear or branched alkylene or cycloalkylene having 1 to 6 carbon atoms,
R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl,
R² is a hydrogen atom, a substituted or unsubstituted C₁ to C₂₀ alkyl, a substituted or unsubstituted C₃ to C₂₀ cycloalkyl, a substituted or unsubstituted C₂ to C₂₀ heterocycloalkyl, a substituted or unsubstituted C₆ to C₂₀ aryl, a substituted or unsubstituted C₁ to C₂₀ heteroaryl, SR⁵, OR⁶, NR⁷R⁸, C(O)R⁹, or C(O)OR¹³,
R⁴ is a group selected from the group consisting of a hydrogen atom, a C₁ to C₁₈ alkyl, a C₂ to C₁₈ alkanoyl, a C₆ to C₁₀ aryl, and a C₇ to C₁₁ aroyl,
R⁵ and R⁶ are each independently a group selected from the group consisting of a hydrogen atom, a C₁ to C₂₀ alkyl, a C₂ to C₂₀ alkanoyl, a C₆ to C₁₀ aryl, and a C₇ to C₁₁ aroyl,
R⁷ and R⁸ are each independently a group selected from the group consisting of a hydrogen atom, a C₁ to C₂₀ alkyl, a C₂ to C₂₀ alkanoyl, a C₇ to C₁₁ aroyl, and a C₆ to C₁₀ aryl,
R⁹ is a group selected from the group consisting of a hydrogen atom, a C₁ to C₂₀ alkyl, and a C₆ to C₂₀ aryl, and
R¹³ has the same definition as that for R¹).
[23] An adhesive sheet comprising:
an adhesive layer formed of an adhesive composition containing a (meth)acrylic polymer (A), a photoinitiator (B), and an ultraviolet absorber (C),
wherein the photoinitiator (B) includes a compound represented by Formula 2,

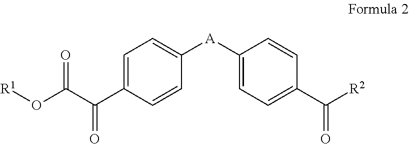

(in Formula 2, A is O, S, NR⁴, or a linear or branched alkylene or cycloalkylene having 1 to 6 carbon atoms,
R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl,
R² is a hydrogen atom, a substituted or unsubstituted C₁ to C₂₀ alkyl, a substituted or unsubstituted C₃ to C₂₀ cycloalkyl, a substituted or unsubstituted C₂ to C₂₀ heterocycloalkyl, a substituted or unsubstituted C₆ to C₂₀ aryl, a substituted or unsubstituted C₁ to C₂₀ heteroaryl, SR⁵, OR⁶, NR⁷R⁸, C(O)R⁹, or C(O)OR¹³,
R⁴ is a group selected from the group consisting of a hydrogen atom, a C₁ to C₁₈ alkyl, a C₂ to C₁₈ alkanoyl, a C₆ to C₁₀ aryl, and a C₇ to C₁₁ aroyl,
R⁵ and R⁶ are each independently a group selected from the group consisting of a hydrogen atom, a C₁ to C₂₀ alkyl, a C₂ to C₂₀ alkanoyl, a C₆ to C₁₀ aryl, and a C₇ to C₁₁ aroyl,
R⁷ and R⁸ are each independently a group selected from the group consisting of a hydrogen atom, a C₁ to C₂₀ alkyl, a C₂ to C₂₀ alkanoyl, a C₇ to C₁₁ aroyl, and a C₆ to C₁₀ aryl,
R⁹ is a group selected from the group consisting of a hydrogen atom, a C₁ to C₂₀ alkyl, and a C₆ to C₂₀ aryl, and
R¹³ has the same definition as that for R¹).

### Advantageous Effects of Invention

The adhesive composition according to the invention of [1] can be suitably used in an adhesive sheet for bonding an optical member, particularly, an adhesive sheet for organic EL display devices, in which the adhesive composition having a small amount of photodecomposition products can be cured with an energy ray on a relatively long wavelength side, for example, an energy ray having a wavelength of more than 380 nm, particularly, an active energy ray having a wavelength of 405 nm.

According to the invention described in [2], an adhesive composition is provided having a small amount of photodecomposition products, ultraviolet absorbability, and that can be cured by active energy rays.

An adhesive sheet formed of the adhesive composition according to the invention of [2] can be suitably used as an adhesive sheet for bonding an optical member, particularly, an adhesive sheet for organic EL display devices, in which the adhesive sheet with a small amount of photodecomposition products has ultraviolet absorbability and can be cured by active energy rays.

### DESCRIPTION OF EMBODIMENTS

Hereinafter, an example of an embodiment of the present invention will be described in detail. However, the present invention is not limited to the embodiment described below.

In the present invention, the term “film” conceptually includes a sheet, a film, and a tape.

In addition, when expressed as a “panel” such as an image display panel and a protective panel, the panel includes a plate body, a sheet, and a film.

In the present invention, when described as “x to y” (x and y are any numbers), unless otherwise specified, the description includes the meaning of “x or more and y or less” and also includes the meaning of “preferably more than x” or “preferably less than y”.

In addition, when described as “x or more” (x is any number), unless otherwise specified, the description includes the meaning of “preferably more than x”; and when described as “y or less” (y is any number), unless otherwise specified, the description includes the meaning of “preferably less than y”.

Furthermore, “x and/or y (x and y are optional configurations)” means at least one of x or y, and means three cases of only x, only y, and x and y.

In addition, in the present invention, “(meth)acrylic” means a concept including acrylic and methacrylic, “(meth)acrylate” means a concept including acrylate and methacrylate, and “(meth)acryloyl” means a concept including acryloyl and methacryloyl.

“(Meth)acrylic polymer” means a polymer having a constitutional unit derived from a (meth)acrylic monomer. The (meth)acrylic polymer may further have a constitutional unit derived from a monomer other than the (meth)acrylic monomer (for example, styrene or the like).

### Adhesive Composition

In the present invention, the adhesive composition is an adhesive composition containing a (meth)acrylic polymer (A), and by containing the (meth)acrylic polymer (A), an adhesive sheet to be obtained can be flexible and have a favorable adhesive force.

### 1. First Embodiment

An adhesive composition according to a first embodiment of the present invention (hereinafter, referred to as “present adhesive composition 1”) contains a (meth)acrylic polymer (A) and a photoinitiator (B), in which the photoinitiator (B) includes a photoinitiator (b1) having a glyoxylate structure and a molar absorption coefficient at a wavelength of 405 nm of 30 (L/mol·cm) or more. The present adhesive composition 1 does not contain an ultraviolet absorber.

The present adhesive composition can be suitably used for bonding an optical member.

Hereinafter, each component contained in the present adhesive composition 1 will be described in detail.

<(Meth)Acrylic Polymer (a)>

Examples of the (meth)acrylic polymer (A) contained in the present adhesive composition 1 include a homopolymer of an alkyl (meth)acrylate and a copolymer obtained by polymerizing a monomer component which is copolymerizable with the homopolymer.

Among these, it is preferable that the (meth)acrylic polymer include two or more copolymerizable components, and at least one of the copolymerizable components be an alkyl (meth)acrylate having 3 to 30 carbon atoms in an alkyl group.

More specifically, examples of the above-described (meth)acrylic polymer (A) include a copolymer of monomer components including the alkyl (meth)acrylate having 3 to 30 carbon atoms in an alkyl group and any one or more monomers copolymerizable with the alkyl (meth)acrylate, the monomers selected from (a1) a carboxy group-containing monomer other than the alkyl (meth)acrylate, (a2) a hydroxyl group-containing monomer, (a3) a nitrogen-containing monomer, (a4) an epoxy group-containing monomer, (a5) a vinyl monomer, (a6) an alkyl (meth)acrylate monomer having 1 or 2 carbon atoms in an alkyl group, (a7) an alicyclic monomer, and (a8) other copolymerizable monomers.

(1) Among the above-described copolymerizable monomers (a1) to (a8), the copolymerizable monomer (a1), (a2), or (a3) is particularly preferable.

(2) In addition, it is particularly preferable that the above-described copolymerizable monomer (a1) not be included, and any of the copolymerizable monomer (a2) or (a3) be included; when any of the copolymerizable monomer (a2) or (a3) is included, it is possible to achieve both anticorrosion properties, adhesiveness, and moisture-heat whitening resistance when an adherend contains a component having corrosiveness, such as metal; In addition, from the viewpoint of improving cohesive property, it is particularly preferable to include both the copolymerizable monomer (a2) and the copolymerizable monomer (a3).

(3) Among the copolymerizable monomers (a3), a copolymerizable monomer (a3) having a tertiary nitrogen atom is preferable from the viewpoint that a sensitizing action of a hydrogen abstraction reaction described later is provided, and as a result, crosslinking can be efficiently formed.

(4) Among the above-described alkyl (meth)acrylates, an alkyl (meth)acrylate containing a tertiary carbon atom in the alkyl group is preferable; by using such an alkyl (meth)acrylate, the hydrogen abstraction reaction is likely to occur during light irradiation, and as a result, crosslinking is likely to be efficiently formed.

The above-described alkyl (meth)acrylate is a linear or branched alkyl (meth)acrylate in which the number of carbon atoms in the alkyl group is 3 to 30, and is represented by Formula (m1).

CH₂═C(R¹⁴)—COO(R¹⁵) Formula (m1)
(in Formula m1, R¹⁴ represents a hydrogen atom or a methyl group, and R¹⁵ represents a linear or branched alkyl group having 3 to 30 carbon atoms)

Examples of the alkyl (meth)acrylate represented by Formula (m1) include linear alkyl (meth)acrylates such as n-propyl (meth)acrylate, i-propyl (meth)acrylate, n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, undecyl (meth)acrylate, lauryl (meth)acrylate, n-tridecyl (meth)acrylate, n-tetradecyl (meth)acrylate, cetyl (meth)acrylate, stearyl (meth)acrylate, icosyl (meth)acrylate, henicosyl (meth)acrylate, and behenyl (meth)acrylate; and branched alkyl (meth)acrylates such as sec-butyl (meth)acrylate, isobutyl (meth)acrylate, t-butyl (meth)acrylate, isopentyl (meth)acrylate, neopentyl (meth)acrylate, 2-ethylhexyl (meth)acrylate, isooctyl (meth)acrylate, isononyl (meth)acrylate, isodecyl (meth)acrylate, isostearyl (meth)acrylate, isoicosyl (meth)acrylate, butyloctyl (meth)acrylate, isomyristyl (meth)acrylate, isocetyl (meth)acrylate, hexyldecyl (meth)acrylate, isostearyl (meth)acrylate, octyldecyl (meth)acrylate, octyldodecyl (meth)acrylate, and isobehenyl (meth)acrylate. These may be used alone or in combination of two or more kinds thereof.

Among the above, a linear alkyl (meth)acrylate is preferable from the viewpoint of obtaining flexibility. In addition, from the viewpoint of balancing adhesiveness and flexibility, an alkyl (meth)acrylate having, in an alkyl group, 3 to 20 carbon atoms, more preferably 5 to 18 carbon atoms, particularly preferably 6 to 16 carbon atoms, and most preferably 7 to 14 carbon atoms is preferable. For example, n-butyl (meth)acrylate, n-pentyl (meth)acrylate, n-hexyl (meth)acrylate, n-octyl (meth)acrylate, n-nonyl (meth)acrylate, decyl (meth)acrylate, or lauryl (meth)acrylate is preferable.

In addition, among the above, from the viewpoint that a hydrogen abstraction reaction described later is likely to occur during light irradiation, and as a result, a crosslinked structure can be efficiently formed, a branched alkyl (meth)acrylate is preferably used, and among these, a branched alkyl (meth)acrylate having, in an alkyl group, 3 to 20 carbon atoms, more preferably 5 to 18 carbon atoms, particularly preferably 6 to 16 carbon atoms, and most preferably 7 to 14 carbon atoms is preferable. For example, sec-butyl (meth)acrylate, isobutyl (meth)acrylate, t-butyl (meth)acrylate, isopentyl (meth)acrylate, neopentyl (meth)acrylate, 2-ethylhexyl (meth)acrylate, isooctyl (meth)acrylate, isononyl (meth)acrylate, or isodecyl (meth)acrylate is preferable.

A proportion of the constitutional unit derived from the above-described alkyl (meth)acrylate to all constitutional units constituting the (meth)acrylic polymer (A) is preferably 5% by mass or more and 95% by mass or less, more preferably 10% by mass or more and 90% by mass or less, still more preferably 15% by mass or more and 85% by mass or less, and particularly preferably 20% by mass or more and 80% by mass or less. When the proportion of the constitutional unit derived from the alkyl (meth)acrylate is equal to or more than the above-described lower limit value, the flexibility tends to be excellent, and unevenness followability when the adherend has unevenness tends to be excellent. When the proportion of the constitutional unit derived from the alkyl (meth)acrylate is equal to or less than the above-described upper limit value, an effect of the copolymerizable monomer described later is easily obtained, and the adhesive composition tends to have excellent adhesive force and cohesive force. The upper limit and upper limit of the contained amount of the constitutional unit derived from the above-described alkyl (meth)acrylate can be arbitrarily combined.

Examples of the above-described carboxy group-containing monomer (a1) include (meth)acrylic acid, 2-(meth)acryloyloxyethyl hexahydrophthalic acid, 2-(meth)acryloyloxypropyl hexahydrophthalic acid, 2-(meth)acryloyloxyethyl phthalic acid, 2-(meth)acryloyloxypropyl phthalic acid, 2-(meth)acryloyloxyethyl maleic acid, 2-(meth)acryloyloxypropyl maleic acid, 2-(meth)acryloyloxyethyl succinic acid, 2-(meth)acryloyloxypropyl succinic acid, crotonic acid, fumaric acid, maleic acid, and itaconic acid. These may be used alone or in combination of two or more kinds thereof.

Examples of the above-described hydroxyl group-containing monomer (a2) include hydroxyalkyl (meth)acrylates such as 2-hydroxyethyl (meth)acrylate, 4-hydroxybutyl (meth)acrylate, 5-hydroxypentyl (meth)acrylate, 6-hydroxyhexyl (meth)acrylate, and 8-hydroxyoctyl (meth)acrylate; caprolactone-modified hydroxyalkyl (meth)acrylates such as caprolactone-modified 2-hydroxyethyl (meth)acrylate; (meth)acrylates having an oxyalkylene structure, such as diethylene glycol (meth)acrylate, polyethylene glycol (meth)acrylate, polypropylene glycol (meth)acrylate, polytrimethylene glycol (meth)acrylate, and polyoxyethylene polyoxypropylene glycol (meth)acrylate; primary hydroxyl group-containing (meth)acrylates such as 2-acryloyloxyethyl-2-hydroxyethyl phthalate; secondary hydroxyl group-containing (meth)acrylates such as 2-hydroxypropyl (meth)acrylate, 2-hydroxybutyl (meth)acrylate, and 3-chloro-2-hydroxypropyl (meth)acrylate; tertiary hydroxyl group-containing (meth)acrylates such as 2,2-dimethyl 2-hydroxyethyl (meth)acrylate; and vinyl ethers such as 2-hydroxyethyl vinyl ether, diethylene glycol monovinyl ether, and 4-hydroxybutyl vinyl ether. These can be used alone or in combination of two or more kinds thereof.

The adhesive sheet can be improved in adhesive force and can suppress moisture-heat whitening by the hydroxyl group-containing monomer (a2). In addition, when the present adhesive composition 1 contains a thermal crosslinking agent described later, the hydroxyl group-containing monomer (a2) is a reaction point for crosslinking.

Among the above-described hydroxyl group-containing monomers (a2), a hydroxyl group-containing monomer having, in a hydroxyalkyl group, 1 to 10 carbon atoms, more preferably 1 to 6 carbon atoms, and particularly preferably 2 to 4 carbon atoms, is preferable. For example, 2-hydroxyethyl (meth)acrylate, 4-hydroxybutyl (meth)acrylate, 2-hydroxypropyl (meth)acrylate, 2-hydroxyethyl vinyl ether, diethylene glycol monovinyl ether, or 4-hydroxybutyl vinyl ether is preferable; and a primary hydroxyl group-containing (meth)acrylate, for example, 2-hydroxyethyl (meth)acrylate or 4-hydroxybutyl (meth)acrylate is particularly preferable.

From the viewpoint of imparting adhesive force and moisture-heat whitening resistance, the contained amount of the constitutional unit derived from the above-described hydroxyl group-containing monomer (a2) in the (meth)acrylic polymer (A) is preferably 3% to 30% by mass, more preferably 5% to 25% by mass, and particularly preferably 7% to 20% by mass with respect to all constitutional units of the (meth)acrylic polymer (A).

Examples of the above-described nitrogen-containing monomer (a3) include an amino group-containing monomer, an amide group-containing monomer, an isocyanate group-containing monomer, and (meth)acrylonitrile. The adhesive sheet can be improved in cohesive force and can suppress moisture-heat whitening by the nitrogen-containing monomer (a3). These may be used alone or in combination of two or more kinds thereof. In addition, the nitrogen-containing monomer (a3) has an action of promoting a hydrogen abstraction reaction described later.

Examples of the above-described amino group-containing monomer as the above-described nitrogen-containing monomer include primary amino group-containing (meth)acrylates such as aminomethyl (meth)acrylate and aminoethyl (meth)acrylate; secondary amino group-containing (meth)acrylates such as t-butylaminoethyl (meth)acrylate and t-butylaminopropyl (meth)acrylate; tertiary amino group-containing (meth)acrylates such as dimethylaminoethyl (meth)acrylate, diethylaminoethyl (meth)acrylate, dimethylaminopropyl (meth)acrylate, diethylaminopropyl (meth)acrylate, and dimethylaminopropyl acrylamide; and monomers such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylacetamides, and N-vinylcaprolactam.

Examples of the above-described amide group-containing monomer include (meth)acrylamide; N-alkyl (meth)acrylamides such as N-methyl (meth)acrylamide, N-ethyl (meth)acrylamide, N-propyl (meth)acrylamide, N-n-butyl (meth)acrylamide, diacetone (meth)acrylamide, and N,N′-methylene bis(meth)acrylamide; N,N-dialkyl (meth)acrylamides such as N,N-dimethyl (meth)acrylamide, N,N-diethyl (meth)acrylamide, N,N-dipropyl (meth)acrylamide, N,N-ethyl methyl acrylamide, and N,N-diallyl (meth)acrylamide; hydroxyalkyl (meth)acrylamides such as N-hydroxymethyl (meth)acrylamide and N-hydroxyethyl (meth)acrylamide; alkoxyalkyl (meth)acrylamides such as N-methoxymethyl (meth)acrylamide and N-(n-butoxymethyl) (meth)acrylamide; and maleimide or a derivative thereof.

Examples of the above-described isocyanate group-containing monomer include 2-(meth)acryloyloxyethyl isocyanate and an alkylene oxide adduct thereof. The isocyanate group may be protected with a blocking agent such as methyl ethyl ketone oxime, 3,5-dimethylpyrazole, 1,2,4-triazole, and diethyl malonate.

Among the above, from the viewpoint of having a sensitizing action of a hydrogen abstraction reaction described later and thus being capable of efficiently forming a crosslinked structure, a monomer having a tertiary nitrogen atom is preferable; and for example, a tertiary amino group-containing (meth)acrylate, N,N-dialkyl (meth)acrylamide, N-vinylpyrrolidone, or acryloylmorpholine is particularly preferable.

From the viewpoint of imparting cohesive force and moisture-heat whitening resistance, the contained amount of the constitutional unit derived from the above-described nitrogen-containing monomer (a3) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described epoxy group-containing monomer (a4) include glycidyl (meth)acrylate, methylglycidyl (meth)acrylate, 3,4-epoxycyclohexylmethyl (meth)acrylate, and 4-hydroxybutyl (meth)acrylate glycidyl ether. These may be used alone or in combination of two or more kinds thereof.

Examples of the above-described vinyl monomer (a5) include a compound having a vinyl group in the molecule. Examples of such a compound include vinyl ester monomers such as vinyl acetate, vinyl propionate, vinyl laurate, and vinyl stearate; and aromatic vinyl monomers such as styrene, chlorostyrene, chloromethylstyrene, α-methylstyrene, and other substituted styrenes. These may be used alone or in combination of two or more kinds thereof.

Examples of the above-described alkyl (meth)acrylate monomer (a6) having 1 or 2 carbon atoms in an alkyl group include methyl (meth)acrylate and ethyl (meth)acrylate. These may be used alone or in combination of two or more kinds thereof.

From the viewpoint of imparting cohesive force to the adhesive sheet, the contained amount of the constitutional unit derived from the copolymerizable monomer (a6) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described alicyclic monomer (a7) include cyclohexyl (meth)acrylate, 3,3,5-trimethylcyclohexyl (meth)acrylate, isobornyl (meth)acrylate, dicyclopentanyl (meth)acrylate, dicyclopentenyloxyethyl (meth)acrylate, t-butylcyclohexyl (meth)acrylate, and adamantyl (meth)acrylate. These may be used alone or in combination of two or more kinds thereof.

From the viewpoint of imparting cohesive force to the adhesive sheet, the contained amount of the constitutional unit derived from the copolymerizable monomer (a7) in the (meth)acrylic polymer (A) is preferably 0.1% to 15% by mass, more preferably 0.5% to 13% by mass, particularly preferably 1% to 10% by mass, and most preferably 2% to 7% by mass with respect to all constitutional units of the (meth)acrylic polymer (A).

Examples of the above-described other copolymerizable monomer (a8) include (meth)acrylates having an alkoxyalkylene glycol skeleton, such as methoxydiethylene glycol (meth)acrylate, methoxypolyethylene glycol (meth)acrylate, butoxypolyethylene glycol (meth)acrylate, methoxypolypropylene glycol (meth)acrylate, butoxypolypropylene glycol (meth)acrylate, methoxypolytetramethylene glycol (meth)acrylate, butoxypolytetramethylene glycol (meth)acrylate, methoxypolyoxyethylene polyoxypropylene glycol (meth)acrylate, and butoxypolyoxyethylene polyoxypropylene glycol (meth)acrylate; aromatic (meth)acrylates having a benzophenone structure, such as phenyl (meth)acrylate, benzyl (meth)acrylate, phenoxyethyl (meth)acrylate, phenyldiethylene glycol (meth)acrylate, phenoxypolyethylene glycol (meth)acrylate, phenoxypolyethylene glycol-polypropylene glycol-(meth)acrylate, and nonylphenol ethylene oxide adduct (meth)acrylate; (meth)acrylates having a benzophenone structure, such as 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloxyethoxybenzophenone, 4-methacryloyloxy-4′-methoxybenzophenone, 4-methacryloxyethoxy-4′-methoxybenzophenone, 4-methacryloyloxy-4′-bromobenzophenone, 4-methacryloxyethoxy-4′-bromobenzophenone, and a mixture thereof, heterocycle-containing (meth)acrylates such as tetrahydrofurfuryl (meth)acrylate; and macromonomers. These can be used alone or in combination of two or more kinds thereof.

The contained amount of the constitutional unit derived from the copolymerizable monomer (a8) in the (meth)acrylic polymer (A) is preferably 1% by mass or more and 30% by mass or less, more preferably 3% by mass or more and 20% by mass or less, and still more preferably 5% by mass or more and 15% by mass or less with respect to all constitutional units constituting the (meth)acrylic polymer (A). The above-described lower limit and upper limit of the above-described contained amount can be arbitrarily combined.

The (meth)acrylic polymer (A) may have a photoactive site, for example, a polymerizable carbon-carbon double bond group introduced into a side chain. In this manner, the crosslinking efficiency of the present adhesive composition 1 can be increased, and the present adhesive composition 1 can be crosslinked in a shorter time, thereby improving productivity.

Examples of a method of introducing the polymerizable carbon-carbon double bond group into the side chain of the (meth)acrylic polymer (A) include a method of preparing a copolymer containing the above-described hydroxyl group-containing monomer (a2) or the above-described functional group-containing ethylenically unsaturated monomer, and condensing or addition-reacting a compound having a functional group capable of reacting with these functional groups and having a polymerizable carbon-carbon double bond group while maintaining the activity of the polymerizable carbon-carbon double bond group.

Examples of a combination of these functional groups include an epoxy group (glycidyl group) and a carboxy group, an amino group and a carboxy group, an amino group and an isocyanate group, an epoxy group (glycidyl group) and an amino group, a hydroxyl group and an epoxy group, and a hydroxyl group and an isocyanate group. Among the combinations of these functional groups, a combination of a hydroxyl group and an isocyanate group is preferable from the viewpoint of ease of reaction control. Among the above, a combination in which the copolymer has a hydroxyl group and the compound has an isocyanate group is preferable.

Examples of the isocyanate compound having a polymerizable carbon-carbon double bond group include 2-(meth)acryloyloxyethyl isocyanate and an alkylene oxide adduct thereof described above.

From the viewpoint of improving adhesiveness and stress relaxing properties, the contained amount of the compound having the functional group that can react with the functional groups and the polymerizable carbon-carbon double bond group is preferably 10 parts by mass or less, more preferably 5 parts by mass or less, still more preferably 1 part by mass or less, and particularly preferably 0.1 parts by mass or less with respect to 100 parts by mass of the (meth)acrylic polymer (A). The lower limit value thereof is usually 0 parts by mass.

From the viewpoint of obtaining the present adhesive composition 1 having high cohesive force, the weight-average molecular weight (Mw) of the (meth)acrylic polymer (A) is preferably 200,000 or more, more preferably 300,000 or more, and still more preferably 400,000 or more.

In addition, from the viewpoint of handleability and uniform stirring property, the upper limit value of the weight-average molecular weight (Mw) of the (meth)acrylic polymer (A) is preferably 1,500,000 or less, more preferably 1,200,000 or less, still more preferably 1,100,000 or less, and particularly preferably 1,000,000 or less. The lower limit and the upper limit of the weight-average molecular weight of the (meth)acrylic polymer (A) can be arbitrarily combined.

The weight-average molecular weight of the (meth)acrylic polymer (A) is a value in terms of standard polystyrene, which is measured by gel permeation chromatography (GPC).

A method of producing the (meth)acrylic polymer (A) is not particularly limited, and a known method can be adopted. For example, a method of polymerizing a monomer mixture including an alkyl (meth)acrylate having 3 to 30 carbon atoms in an alkyl group and one or more selected from the copolymerizable monomers (a1) to (a8) used as necessary can be used.

### <Photoinitiator (B)>

The present adhesive composition 1 contains, as the photoinitiator (B), a photoinitiator (b1) having a glyoxylate structure and a molar absorption coefficient at a wavelength of 405 nm of 30 (L/mol·cm) or more.

The photoinitiator is a compound that generates a radical by active energy ray.

The photoinitiator is broadly classified into two types, based on a radical generation mechanism. More specifically, the photoinitiator is broadly classified into a cleavage-type photoinitiator that can generate a radical by cleaving a single bond of the initiator itself, and a hydrogen abstraction-type photoinitiator that can generate a radical by abstracting hydrogen from a hydrogen donor in the system by an excited initiator.

In the cleavage-type photoinitiator, since the initiator itself is a radical, and the radical adds to a polymerizable carbon-carbon double bond group in the system to promote a radical addition reaction, it is necessary for the (meth)acrylic polymer (A) to have a polymerizable carbon-carbon double bond group or a certain amount or more of a polymerizable carbon-carbon double bond group of a polyfunctional (meth)acrylate in order to obtain sufficient active energy ray curability. When a certain amount or more of a polyfunctional (meth)acrylate (D) is added, the reaction of the polyfunctional (meth)acrylate (D) proceeds rapidly by light irradiation during the manufacturing of the adhesive sheet, and thus there are problems such as difficulty in controlling a state in which there is room for curing by active energy ray, and a decrease in adhesive force.

On the other hand, since the hydrogen abstraction-type photoinitiator abstracts hydrogen from the hydrogen donor such as the (meth)acrylic polymer (A) in the system and thus a radical is generated in the (meth)acrylic polymer (A), the (meth)acrylic polymer (A) itself can be bonded by a radical addition reaction even when the system does not have the polymerizable carbon-carbon double bond group, so that sufficient active energy ray curability can be obtained, which is preferable.

In addition, as a photoinitiator having high photosensitivity to light in a long wavelength range, α-aminoacetophenone-based photoinitiators or acylphosphine oxide-based photoinitiators have been mainly used, but these are cleavage-type photoinitiators, so that, for example, outgas such as benzaldehyde is generated as a photodecomposition product, and thus improvement has been strongly desired.

In addition, the hydrogen abstraction-type photoinitiators such as thioxanthone and anthraquinone, which are known in the related art as photoinitiators having photosensitivity to light in a long wavelength range, do not generate photodecomposition products, but have a problem of yellowing, and thus the use thereof is limited.

Under such circumstances, the present inventors have conducted intensive studies and have obtained the following findings.

As the glyoxylate-based hydrogen abstraction-type photoinitiator, it is considered that the curing reaction does not proceed because the efficiency of hydrogen abstraction from the hydrogen donor is low in light in a long wavelength range. However, by using the glyoxylate-based hydrogen abstraction-type photoinitiator having a molar absorption coefficient at a wavelength of 405 nm of 30 (L/mol·cm) or more, it is found that the curing is carried out by an energy ray on a long wavelength side, for example, an energy ray having a wavelength of 405 nm without any problems such as insufficient curing or yellowing, thus completing the present invention.

The above-described glyoxylate-based photoinitiator is preferably a compound having an absorption wavelength of 380 to 430 nm.

In the photoinitiator (b1), the molar absorption coefficient at 405 nm is 30 (L/mol·cm) or more, whereby sensitivity to long-wavelength active energy rays is excellent. Therefore, with the photoinitiator (b1), it is possible to obtain the present adhesive composition 1 that can be cured by active energy rays having a relatively long wavelength, for example, active energy rays having a wavelength of 405 nm, which is longer than 380 nm. From such a viewpoint, the above-described molar absorption coefficient is preferably 40 (L/mol·cm) or more, more preferably 50 (L/mol·cm) or more, still more preferably 60 (L/mol·cm) or more, and particularly preferably 70 (L/mol·cm) or more.

From the viewpoint of internal (or deep) curability, the upper limit of the above-described molar absorption coefficient is preferably 1.0×10⁶ (L/mol·cm) or less, more preferably 5.0×10⁵ (L/mol·cm) or less, still more preferably 1.0×10⁵ (L/mol·cm) or less, and particularly preferably 5.0×10⁴ (L/mol·cm) or less.

The above-described lower limit and upper limit of the above-described molar absorption coefficient can be arbitrarily combined.

The molar absorption coefficient of the photoinitiator (b1) at 405 nm is obtained by dissolving the photoinitiator (b1) at a predetermined concentration in chloroform or the like, measuring an absorbance at 405 nm using an ultraviolet-visible spectrophotometer, and calculating from the obtained absorbance according to the following expression.

A=εL_{C}

(A represents an absorbance, F represents a molar absorption coefficient (L/mol·cm), c represents a molar concentration (mol/L) of the photoinitiator (b1), and L represents an optical path length (cm))

The photoinitiator (b1) has a glyoxylate structure represented by Formula 1.

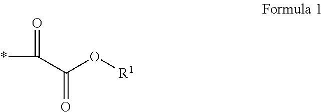

In Formula 1, R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl, and * represents a bonding site.

The “C₁ to C₂₀ alkyl” means an alkyl group having 1 to 20 carbon atoms. The same applies to the C₃ to C₂₀ cycloalkyl, the C₂ to C₂₀ heterocycloalkyl, and the like.

In Formula 1, when R¹ is a C₁ to C₂₀ alkyl, the C₁ to C₂₀ alkyl may be interrupted by one or more identical or different groups selected from the group consisting of O, S, N(R³), C(O), C(O)O, and OC(O), or may have one or more identical or different groups R^{1a}.

Here, R^{1a}'s are each independently selected from the group consisting of F, Cl, Br, I, CN, NO₂, SR⁵, OR⁶, NR⁷R⁸, C(O)R⁹, C(O)OR¹⁰, C(O)NR¹¹R¹², and a C₃ to C₂₀ cycloalkyl, a C₆ to C₁₀ aryl, or a (meth)acryloyloxy group, which may be interrupted by one or more C(O) groups.

The C₃ to C₂₀ cycloalkyl and the C₆ to C₁₀ aryl in R^{1a} may have one or more identical or different groups R^{1aa}.

R^{1aa}'s are each independently selected from the group consisting of a C₁ to C₁₂ alkyl, a C₂ to C₁₂ alkenyl, F, Cl, Br, I, NO₂, SR⁵, OR⁶, and NR⁷R⁸.

The C₁ to C₁₂ alkyl in R^{1aa} may be interrupted by one or more groups selected from the group consisting of O, S, N(R³), C(O), C(O)O, and OC(O), and may have one or more identical or different groups selected from the group consisting of F, Cl, Br, I, NO₂, SR⁵, OR⁶, NR⁷R⁸, C(O)R⁹, C(O)OR¹⁰, and C(O)NR¹¹R¹².

In Formula 1, when R¹ is a C₃ to C₂₀ cycloalkyl or a C₂ to C₂₀ heterocycloalkyl, the C₃ to C₂₀ cycloalkyl or the C₂ to C₂₀ heterocycloalkyl may be interrupted by one or more C(O) groups, or may have one or more identical or different groups R^{1b}.

Here, R^{1b}'s are each independently selected from the group consisting of C₁ to C₁₂ alkyl, C₂ to C₁₂ alkenyl, F, Cl, Br, I, CN, NO₂, SR⁵, OR⁶, and NR⁷R⁸. The C₁ to C₁₂ alkyl in R^{1b} may have one or more identical or different groups selected from the group consisting of F, Cl, Br, I, NO₂, SR⁵, OR⁶, NR⁷R⁸, C(O)R⁹, C(O)OR¹⁰, and C(O)NR¹¹R¹².

R³ is selected from the group consisting of a hydrogen atom, a C₁ to C₁₈ alkyl, a C₂ to C₁₈ alkanoyl, a C₆ to C₁₀ aryl, and a C₇ to C₁₁ aroyl.

The C₁ to C₁₈ alkyl in R³ may be interrupted by one or more groups selected from the group consisting of O, S, N(C₁ to C₁₂ alkyl), C(O), C(O)O, and OC(O), and may have one or more identical or different groups selected from the group consisting of F, Cl, Br, I, a C₃ to C₁₀ cycloalkyl, a C₂ to C₁₀ heterocycloalkyl, a C₆ to C₁₀ aryl, OH, and SH.

The C₂ to C₂₀ alkanoyl in R³ may be interrupted by one or more groups selected from the group consisting of O, S, CO, C(O)O, and OC(O), and may have one or more identical or different groups selected from the group consisting of F, Cl, Br, I, a C₃ to C₁₀ cycloalkyl, a C₂ to C₁₀ heterocycloalkyl, and a C₆ to C₁₀ aryl.

The C₆ to C₁₀ aryl in R³ may have one or more identical or different groups selected from the group consisting of F, Cl, Br, I, a C₁ to C₁₀ alkyl, a C₁ to C₁₀ alkoxy, and a C₂ to C₁₁ acyloxy.

The C₇ to C₁₁ aroyl in R³ may have one or more identical or different groups selected from the group consisting of F, Cl, Br, I, C₁ to C₁₀ alkyl, a C₁ to C₁₀ alkoxy, and a C₂ to C₁₁ acyloxy.

R⁵ and R⁶ are each independently selected from the group consisting of a hydrogen atom, a C₁ to C₂₀ alkyl, a C₂ to C₂₀ alkanoyl, a C₆ to C₁₀ aryl, and a C₇ to C₁₁ aroyl.

The C₁ to C₂₀ alkyl in R⁵ and R⁶ may be interrupted by one or more groups selected from the group consisting of O, S, N(C₁ to C₁₂ alkyl), C(O), C(O)O, and OC(O), and may have one or more identical or different groups selected from the group consisting of F, Cl, Br, I, a C₃ to C₁₀ cycloalkyl, a C₂ to C₁₀ heterocycloalkyl, a C₆ to C₁₀ aryl, OH, and SH.

The C₂ to C₂₀ alkanoyl in R⁵ and R⁶ may be interrupted by one or more groups selected from the group consisting of O, S, C(O), C(O)O, and OC(O), and may have one or more identical or different groups selected from the group consisting of F, Cl, Br, I, a C₃ to C₁₀ cycloalkyl, a C₂ to C₁₀ heterocycloalkyl, and a C₆ to C₁₀ aryl. The C₆ to C₁₀ aryl in R⁵ and R⁶ may have one or more identical or different groups selected from the group consisting of F, Cl, Br, I, a C₁ to C₆ alkyl, a C₁ to C₁₀ alkoxy, and a C₂ to C₁₁ acyloxy.

The C₇ to C₁₁ aroyl in R⁵ and R⁶ may have one or more identical or different groups selected from the group consisting of F, Cl, Br, I, C₁ to C₁₀ alkyl, a C₁ to C₁₀ alkoxy, and a C₂ to C₁₁ acyloxy.

R⁷ and R⁸ are each independently selected from the group consisting of a hydrogen atom, a C₁ to C₂₀ alkyl, a C₂ to C₂₀ alkanoyl, a C₇ to C₁₁ aroyl, and a C₆ to C₁₀ aryl.

The C₁ to C₂₀ alkyl in R⁷ and R⁸ may be interrupted by one or more groups selected from the group consisting of O, S, N(C₁ to C₁₂ alkyl), C(O), C(O)O, and OC(O), and may have one or more identical or different groups selected from the group consisting of F, Cl, Br, I, NO₂, a C₃ to C₁₀ cycloalkyl, heterocycloalkyl, phenyl, OH, SH, and CN.

The C₂ to C₂₀ alkanoyl in R⁷ and R⁸ may be interrupted by one or more groups selected from the group consisting of O and S, and may have one or more identical or different groups selected from the group consisting of F, Cl, Br, I, OH, and a C₁ to C₆ alkoxy.

The C₇ to C₁₁ aroyl in R⁷ and R⁸ may have one or more identical or different groups selected from the group consisting of F, Cl, Br, I, a C₁ to C₆ alkyl, —OH, and a C₁ to C₆ alkoxy.

The C₆ to C₁₀ aryl in R⁷ and R⁸ may have one or more identical or different groups selected from the group consisting of F, Cl, Br, I, a C₁ to C₆ alkyl, —OH, and a C₁ to C₆ alkoxy.

R⁷ and R⁸ may form, together with a nitrogen atom to which they are bonded, a saturated 5-membered, 6-membered, or 7-membered nitrogen heterocyclic ring; where the ring may have, as a ring member, a group selected from the group consisting of O, S, N(C₁ to C₁₂ alkyl), C(O), and C(O)O, and the ring may have one or more C₁ to C₄ alkyls.

R⁹ is selected from the group consisting of a hydrogen atom, a C₁ to C₂₀ alkyl, and a C₆ to C₂₀ aryl.

The C₁ to C₂₀ alkyl in R⁹ may be interrupted by one or more groups selected from the group consisting of O, S, and C(O), or may have one or more identical or different R^{9a}'s.

R^{9a}'s are each independently selected from the group consisting of F, Cl, Br, I, a C₃ to C₁₀ cycloalkyl, heterocycloalkyl, phenyl, OH, and SH.

The C₆ to C₂₀ aryl in R⁹ may have one or more identical or different groups selected from the group consisting of F, Cl, Br, I, SR⁵, OR⁶, N⁷R, a C₁ to C₁₂ alkyl, and a C₂ to C₁₂ acyloxy.

R¹⁰ has the same definition as that for R⁶.

R¹¹ and R¹² have the same definition as those for R⁷ and R⁸.

By having the glyoxylate structure, the photoinitiator (b1) functions as the hydrogen abstraction-type photoinitiator.

The hydrogen abstraction-type photoinitiator is preferable from the viewpoint that photodecomposition products are not generated as in the cleavage-type photoinitiator. In addition, the hydrogen abstraction-type photoinitiator is also preferable from the viewpoint that the (meth)acrylic polymer (A) is also subjected to the hydrogen abstraction reaction, and the (meth)acrylic polymer (A) is incorporated into the crosslinked structure, whereby a crosslinked structure having many crosslinking points is easily formed.

The hydrogen abstraction-type photoinitiator is roughly classified into an intermolecular hydrogen abstraction-type photoinitiator which abstracts hydrogen from another molecule and an intramolecular hydrogen abstraction-type photoinitiator which also causes the hydrogen abstraction reaction in the same molecule. The photoinitiator (b1) functions as the intramolecular hydrogen abstraction-type photoinitiator due to the presence of the above-described glyoxylate structure.

The intramolecular hydrogen abstraction-type photoinitiator is preferable from the viewpoint that it can be a radical generation site not only of the hydrogen donor in the system but also of itself.

From the viewpoint of solubility, R¹ is preferably a linear or branched alkyl group or a cycloalkyl group, and more preferably a linear or branched alkyl group.

From the viewpoint of photocurability, the number of carbon atoms in the alkyl group of R¹ is preferably 1 to 20, more preferably 1 to 12, still more preferably 1 to 8, and particularly preferably 1 or 2.

From the viewpoint of photocurability, the number of carbon atoms in the cycloalkyl group of R¹ is preferably 3 to 20 and more preferably 3 to 10.

The photoinitiator (b1) is preferably a compound having two or more radical-generating groups in the molecule (provided that at least one radical-generating group is the glyoxylate structure). Here, the “radical-generating group” means a group that generates a radical to initiate a polymerization reaction under excitation with active energy ray.

The “radical-generating group” is particularly preferably a structure which is excited by irradiation with active energy ray and generates a radical by causing the hydrogen abstraction reaction.

When the photoinitiator (b1) includes two or more radical-generating groups, the present adhesive composition 1 can efficiently form crosslinks.

Examples of the radical-generating group other than the glyoxylate structure include a benzophenone structure, a benzyl structure, a thioxanthone structure, a 3-ketocoumarin structure, an anthraquinone structure, and a camphorquinone structure.

From the viewpoint of increasing the sensitivity to the long-wavelength active energy rays and the molar absorption coefficient at a wavelength of 405 nm, the photoinitiator (b1) is preferably a compound having a biphenyl structure to which a bond of the glyoxylate structure represented by Formula 1 is bonded, and particularly preferably a compound having a biphenyl sulfide structure to which the bonding site of the glyoxylyate structure represented by Formula 1 is bonded.

Examples of the photoinitiator (b1) include a compound represented by Formula 2.

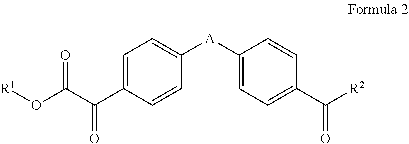

In Formula 2, A is O, S, NR⁴, or a linear or branched alkylene or cycloalkylene having 1 to 6 carbon atoms.

Here, R⁴ has the same definition as that for R³. R¹ is the same as in Formula 1.

R² is a hydrogen atom, a substituted or unsubstituted C₁ to C₂₀ alkyl, a substituted or unsubstituted C₃ to C₂₀ cycloalkyl, a substituted or unsubstituted C₂ to C₂₀ heterocycloalkyl, a substituted or unsubstituted C₆ to C₂₀ aryl, a substituted or unsubstituted C₁ to C₂₀ heteroaryl, SR⁵, OR⁶, NR⁷R⁸, C(O)R⁹, or C(O)OR¹³. Here, R¹³ has the same definition as that for R¹.

In Formula 2, when R² is a C₁ to C₂₀ alkyl, the C₁ to C₂₀ alkyl may be interrupted by a group selected from the group consisting of one or two or more identical or different groups of O, S, N(R³), C(O), C(O)O, and OC(O), or may have one or two or more identical or different groups R^{2a}.

Here, R^{2a} has the same definition as that for R^{1a}.

In Formula 2, when R² is a C₃ to C₂₀ cycloalkyl or a C₂ to C₂₀ heterocycloalkyl, the C₃ to C₂₀ cycloalkyl or C₂ to C₂₀ heterocycloalkyl may be interrupted by one or two or more C(O) groups, or may have one or two or more identical or different groups R^{2b}. Here, R^{2b} has the same definition as that for R^{1b}.

In Formula 2, when R² is a C₆ to C₂₀ aryl or a C₁ to C₂₀ heteroaryl, the C₆ to C₂₀ aryl or the C₁ to C₂₀ heteroaryl may have one or two or more identical or different groups R^{2c}.

R^{2c} 's are each independently selected from the group consisting of a C₁ to C₁₂ alkyl, a C₂ to C₁₂ alkenyl, F, Cl, Br, I, CN, NO₂, SR⁵, OR⁶, NR⁷R⁸, C(O)R⁹, C(O)OR¹⁰, C(O)NR¹¹R¹², a C₆ to C₁₀ aryl, a C₁ to C₂₀ heteroaryl, a C₃ to C₁₀ cycloalkyl, and a C₂ to C₁₀ heterocycloalkyl.

The C₁ to C₁₂ alkyl in R^{2c} may have one or more identical or different groups selected from F, Cl, Br, I, NO₂, SR⁵, OR⁶, NR⁷R⁸, C(O)R⁹, C(O)OR¹⁰, and C(O)NR¹¹R¹².

The C₁ to C₁₂ alkyl, the C₃ to C₁₀ cycloalkyl, and the C₂ to C₁₀ heterocycloalkyl in R^{2c} may be interrupted by one or more C(O) groups.

The C₆ to C₁₀ aryl, the C₁ to C₂₀ heteroaryl, the C₃ to C₁₀ cycloalkyl, and the C₂ to C₁₀ heterocycloalkyl in R²⁰ may have one or two or more identical or different groups R^{1ca}. Here, R^{1ca} has the same definition as that for R^{1aa} described above.

Among the compounds represented by Formula 2, from the viewpoint of photoreactivity, a diphenylsulfide derivative in which A in the formula is a sulfur atom is preferable.

In addition, among the above, from the viewpoint of photoreactivity, R² is preferably a substituted or unsubstituted aromatic group having 6 to 20 carbon atoms or (O)OR¹³. R¹³ has the same definition as that for R¹.

As the photoinitiator (b1), one or more selected from compounds represented by Formulae 3 to 5 are more preferable.

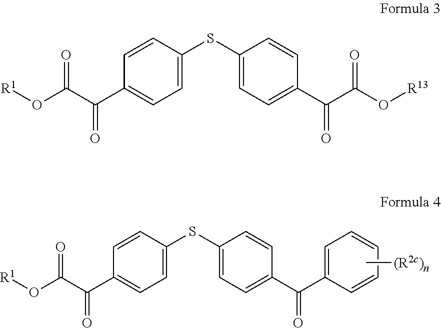

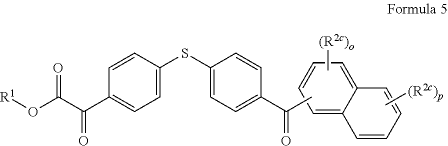

Here, o is an integer of 0 to 3 and p is an integer of 0 to 4.

Among the above, from the viewpoint of photoreactivity, the photoinitiator (b1) preferably includes a compound in which, in Formulae 3 to 5, R¹ and R¹³ are a linear or branched alkyl having 1 to 8 carbon atoms, and n, o, and p are 0; and particularly preferably includes any one or both of a compound represented by Formula 3-1 and a compound represented by Formula 4-1.

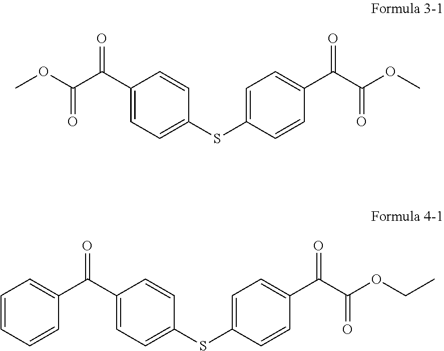

The photoinitiator (b1) can be used alone or in combination of two or more kinds thereof.

The contained amount of the photoinitiator (b1) in the present adhesive composition 1 is preferably 0.1 parts by mass or more, more preferably 0.5 parts by mass or more, and still more preferably 1 part by mass or more with respect to 100 parts by mass of the (meth)acrylic polymer (A). In addition, the upper limit thereof is preferably 10 parts by mass or less, more preferably 8 parts by mass or less, still more preferably 5 parts by mass or less, and particularly preferably 3 parts by mass or less. When the contained amount of the photoinitiator (b1) is equal to or more than the above-described lower limit value, curing failure tends to be prevented; and when the contained amount of the photoinitiator (b1) is equal to or less than the above-described upper limit value, the photoinitiator (b1) is prevented from bleeding out, and the problem of embrittlement or coloration tends to be suppressed. The above-described lower limit and upper limit of the contained amount of the photoinitiator (b1) can be arbitrarily combined.

As long as the effect of the present invention is not impaired, the present adhesive composition 1 may contain a photoinitiator (b2) other than the photoinitiator (b1), as the photoinitiator (B). The photoinitiator (b2) may be any of the hydrogen abstraction-type photoinitiator or the cleavage-type photoinitiator, and each may be used alone or both may be used in combination, and one or two or more kinds thereof may be used in combination.

The terms in the photoinitiator (b1) described above are defined as follows.

The term “alkyl” in the photoinitiator (b1) generally refers to a saturated linear or branched hydrocarbon group having 1 to 20 carbon atoms, preferably 1 to 12 carbon atoms and more preferably 1 to 10 carbon atoms. Examples of the alkyl group include methyl, ethyl, n-propyl, isopropyl, n-butyl, isobutyl, s-butyl, t-butyl, n-pentyl, neopentyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-octadecyl, and n-eicosyl.

The alkyl may be interrupted by one or more identical or different groups selected from O, S, N(R³), C(O), C(O)O, and OC(O). When a plurality of O, S, N(R³), C (O), C (O) O, and OC (O) are present, they are generally isolated from each other by at least one methylene group. R³ is as defined above. Examples of an alkyl interrupted by one or more O atoms include —CH₂—O—CH₃, —CH₂CH₂—O—CH₂CH₃, —[CH₂CH₂O]_{y}—CH₃ (y is 1 to 9), —(CH₂CH₂O)_{y}CH₂CH₃ (y is 1 to 9), —CH₂—CH(CH₃)—O—CH₂—CH₂CH₃, —CH₂—CH₂CH(CH₃)—O—CH₂—CH₂CH₃, —CH₂—CH₂CH(CH₃)—O—CH₂CH₃, —CH₂—CH₂CH(CH₃)—O—CH₃, and CH₂CH(CH₃)—O—CH₂CH₃.

The term “cycloalkyl” in the photoinitiator (b1) refers to a monocyclic or polycyclic aliphatic group usually having 3 to 20 carbon atoms, preferably 3 to 16 carbon atoms and more preferably 3 to 12 carbon atoms.

Examples of the monocyclic aliphatic group include cyclopropyl, cyclobutyl, cyclopentyl, cyclohexyl, cycloheptyl, and cyclooctyl; and cyclopentyl or cyclohexyl is particularly preferable.

Examples of the polycyclic ring include perhydroanthracyl, perhydronaphthyl, perhydrofluorenyl, perhydrocrysenyl, perhydropicenyl, adamantyl, bicyclo[1.1.1]pentyl, bicyclo[2.2.1]heptyl, bicyclo[4.2.2]decyl, bicyclo[2.2.2]octyl, bicyclo[3.3.0]octyl, bicyclo[3.3.2]decyl, bicyclo[4.4.0]decyl, bicyclo[4.3.2]undecyl, bicyclo[4.3.3]dodecyl, bicyclo[3.3.3]undecyl, bicyclo[4.3.1]decyl, bicyclo[4.2.1]nonyl, bicyclo[3.3.1]nonyl, and bicyclo[3.2.1]octyl.

The cycloalkyl may be interrupted by one or more C(O) groups. An example of a cycloalkyl interrupted by one C(O) is 3-oxobicyclo[2.2.1]heptyl.

The term “heterocycloalkyl” in the photoinitiator (b1) generally refers to a 3- to 8-membered, particularly a 5-, 6-, 7-, or 8-membered monocyclic heterocyclic non-aromatic group and bicyclic heterocyclic non-aromatic group. The above-described monocyclic and bicyclic non-aromatic groups may be saturated or unsaturated. In addition, the above-described monocyclic and bicyclic heterocyclic non-aromatic groups usually contain, as a ring member, a heteroatom selected from N, O, and S, particularly one or two heteroatoms; and in this case, an S atom as a ring member may be present as S, SO, or SO₂. The heterocycloalkyl may be interrupted by one or more C(O) groups, usually one or two C(O) groups.

Examples of a saturated or unsaturated 3- to 8-membered non-aromatic heterocyclic group include oxiranyl, oxetanyl, thietanyl, thietanyl-S-oxide (S-oxothietanyl), thietanyl-S-dioxide (S-dioxothietanyl), pyrrolidinyl, pyrazolinyl, imidazolinyl, pyrrolinyl, pyrazolinyl, imidazolinyl, tetrahydrofuranyl, dihydrofuranyl, 1,3-dioxolanyl, dioxolenyl, thiolanil, S-oxothiolanil, S-dioxothiolanil, dihydrothienyl, S-oxodihydrothienyl, S-dioxodihydrothienyl, oxazolidinyl, isoxazolidinyl, oxazolinyl, isoxazolininyl, thiazolinyl, isothiazolinyl, thiazolidinyl, isothiazolidinyl, oxathiolanil, piperidinyl, piperazinyl, pyranil, dihydropyranil, tetrahydropyranil, 1,3- and 1,4-dioxanyl, thiopyranil, S-oxothiopyranil, S-dioxothiopyranil, dihydrothiopyranil, S-oxodihydrothiopyranil, S-dioxodihydrothiopyranil, tetrahydrothiopyranil, S-oxotetrahydrothiopyranil, S-dioxotetrahydrothiopyranil, morpholinyl, thiomorpholinyl, S-oxothiomorpholinyl, S-dioxothiomorpholinyl, and thiazidinyl.

Examples of a heterocyclic ring containing one or two carbonyl groups as a ring member include pyrrolidin-2-onyl, pyrrolidin-2,5-dionyl, imidazolidin-2-onyl, oxazolidin-2-onyl, and thiazolidin-2-onyl.

The term “aryl” in the photoinitiator (b1) refers to a monovalent monocyclic aromatic group and polycyclic aromatic group, each of which has a ring carbon atom. Examples of the monocyclic aromatic group include phenyl. Examples of the polycyclic aromatic group include a bicyclic, tricyclic, or tetracyclic aromatic group, for example, naphthyl, phenanthrenyl, anthracenyl, or pyrenyl. Preferred examples of the aryl are phenyl and naphthyl. The substituted phenyl is substituted with 1, 2, 3, 4, or 5 substituents. The naphthyl is usually substituted with 1, 2, 3, 4, 5, 6, or 7 substituents, preferably with 1, 2, 3, or 4 substituents. Examples of the substituted phenyl include pentafluorophenyl, 2-methylphenyl, 3-methylphenyl, 4-methylphenyl, 2-ethylphenyl, 3-ethylphenyl, 4-ethylphenyl, 2-methoxyphenyl, 3-methoxyphenyl, 4-methoxyphenyl, 2-ethoxyphenyl, 3-ethoxyphenyl, 4-ethoxyphenyl, 3-nitrophenyl, 4-nitrophenyl, 2-chlorophenyl, 3-chlorophenyl, 4-chlorophenyl, 3-vinylphenyl, 4-vinylphenyl, 4-trifluoromethylphenyl, and 3,5-diethoxycarbonylphenyl.

The term “heteroaryl” in the photoinitiator (b1) generally refers to an aromatic group which is an unsubstituted monocyclic heterocyclic group and polycyclic heterocyclic group. The heteroaryl usually contains, as a ring member, one or more carbon atoms and one, two, three, or four heteroatoms selected from N, O, and S. Examples of the monocyclic heteroaromatic group include 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 3-isoxazolyl, 4-isoxazolyl, or 5-isoxazolyl, 3-isothiazolyl, 4-isothiazolyl, or 5-isothiazolyl, 1-imidazolyl, 2-imidazolyl, 4-imidazolyl, 2- or 5-[1,3,4]oxadiazolyl, 4- or 5-(1,2,3-oxadiazolyl), 3- or 5-(1,2,4-oxadiazolyl), 2- or 5-(1,3,4-thiadiazolyl), 2- or 5-(1,3,4-thiadiazolyl), 4- or 5-(1,2,3-thiadiazolyl), 3- or 5-(1,2,4-thiadiazolyl), 1H-, 2H-, or 3H-1,2,3-triazole-4-yl, 1,3,4-triazole-2-yl, 2H-triazole-3-yl, 1H-,2H- or 4H-1,2,4-triazolyl, 1H- or 2H-tetrazolyl, 2-pyridynyl, 3-pyridynyl, 4-pyridynyl, 3-pyridazinyl, 4-pyridazinyl, 2-pyrimidinyl, 4-pyrimidinyl, 5-pyrimidinyl, and 2-pyrazinyl. Examples of the polycyclic heterocyclic group include benzofuranyl, benzothienyl, indolyl, indazolyl, benzimidazolyl, benzoxathazolyl, benzoxadiazolyl, benzothiadiazolyl, benzoxadynyl, quinolinyl, isoquinolinyl, prynyl, 1,8-naphthyridyl, pteridyl, pyrido[3,2-d]pyrimidyl, pyridoimidazolyl, carbazoyl, and acridinyl.

The term “alkanoyl” in the photoinitiator (b1) is alkyl-C(O), and refers to a group which is bonded at any position in the saturated linear or branched alkyl group usually having 3 to 20 carbon atoms defined above through a carbon atom of a carbonyl group; for example, acetyl, propanoyl, 2-methyl-propanoyl, butanoyl, pentanoyl, or hexanoyl.

The term “aroyl” in the photoinitiator (b1) is aryl-C(O), and refers to a group which is bonded to any position in the aryl group defined above through a carbon atom of a carbonyl group; for example, benzoyl and naphthoyl.

The term “heteroaroyl” in the photoinitiator (b1) is heteroaryl-C(O), and refers to a group which is bonded at any position in the heteroaryl group defined above through a carbon atom of a carbonyl group.

The term “alkylene” in the photoinitiator (b1) refers to each alkyl group having a carbon atom defined above, in which one hydrogen atom at any position of the alkyl group is replaced with one further bonding site to form a divalent group. Accordingly, examples of the C₁ to C₆ alkylene include a divalent branched or non-branched saturated aliphatic chain having 1 to 6 carbon atoms, for example, —CH₂—, —CH₂CH₂—, —CH(CH₃)—, —CH₂CH₂CH₂—, —CH(CH₃)CH₂—, —C(CH₃)₂-, —CH₂CH₂CH₂CH₂—, —CH₂CH(CH₃)CH₂—, —CH(CH₃)CH(CH₃)—, —CH₂CH₂CH₂CH₂CH₂—, —CH₂CH₂CH₂CH(CH₃)—, —CH₂C(CH₃)₂CH₂—, and —CH₂CH₂CH₂CH₂CH₂CH₂-.

The term “cycloalkylene” in the photoinitiator (b1) refers to the cycloalkyl group defined above, in which one hydrogen atom at any position of the cycloalkyl is replaced with one further bonding site to form a divalent group. In the polycyclic cycloalkylene, bonding points thereof are located in the same ring or in different rings. Examples of the monocyclic ring include cyclopropylene, cyclobutylene, cyclopentylene, cyclohexylene, and cycloheptylene; and cyclohexylene is particularly preferable. Examples of the polycyclic ring include perhydroanthracylene, perhydronaphthylene, perhydrofluorenylene, perhydrocyclopentadienylene, perhydrocyclopentadienylene, adamantylene, bicyclo[1.1.1]pentylene, bicyclo[2.2.1]heptylene, bicyclo[4.2.2]decylene, bicyclo[2.2.2]octylene, bicyclo[3.3.2]decylene, bicyclo[4.3.2]undecylene, bicyclo[4.3.3]dodecylene, bicyclo[3.3.3]undecylene, bicyclo[4.3.1]decylene, bicyclo[4.2.1]nonylene, bicyclo[3.3.1]nonylene, and bicyclo[3.2.1]octylene.

Examples of the hydrogen abstraction-type photoinitiator as the above-described photoinitiator (b2) include intermolecular hydrogen abstraction-type photoinitiators such as benzophenone, 4-methylbenzophenone, 2,4,6-trimethylbenzophenone, 4-phenylbenzophenone, 3,3′-dimethyl-4-methoxybenzophenone, methyl 2-benzoylbenzoate, 4-[(4-methylphenyl)thio]benzophenone, 4-acryloyloxybenzophenone, 4-acryloyloxyethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxybenzophenone, 4-methacryloxyethoxybenzophenone, 4-methacryloyloxy-4′-methoxybenzophenone, 4-methacryloxyethoxy-4′-methoxybenzophenone, 4-methacryloyloxy-4′-bromobenzophenone, and 4-methacryloxyethoxy-4′-bromobenzophenone; and intramolecular hydrogen abstraction-type photoinitiators such as methyl benzoylformate, oxyphenyl acetate-2-(2-oxo-2-phenylacetoxy-ethoxy)ethyl ester, and oxyphenyl acetate-2-(2-hydroxy-ethoxy)ethyl ester.

Among the above, 4-acryloyloxybenzophenone, 4-acryloyloxyethoxybenzophenone, 4-acryloyloxy-4′-methoxybenzophenone, 4-acryloyloxyethoxy-4′-methoxybenzophenone, or the like, which has a radically polymerizable functional group having a carbon-carbon double bond in the molecule, is preferable from the viewpoint that the polymerization structure is incorporated after the photoreaction, thereby suppressing the bleeding out of the photoinitiator and improving the cohesive force of the adhesive sheet.

In addition, the intramolecular hydrogen abstraction-type photoinitiator is preferable because it can be a radical generation site not only of the hydrogen donor in the system but also of itself.

In addition, as the photoinitiator (b2), a cleavage-type photoinitiator may also be used to the extent that the photodecomposition product does not affect the quality. The cleavage-type photoinitiator is preferable from the viewpoint of high photosensitivity. Examples of the above-described cleavage-type photoinitiator include 2,2-dimethoxy-1,2-diphenylethan-1-one, 1-hydroxycyclohexylphenylketone, 2-hydroxy-2-methyl-1-phenyl-propan-1-one, 1-[4-(2-hydroxyethoxy)phenyl]-2-hydroxy-2-methyl-1-propan-1-one, 2-hydrodooxy-1-{4-[4-(2-hydroxy-2-methyl-propionyl)benzyl]phenyl}-2-methyl-propan-1-one, oligo(2-hydroxy-2-methyl-1-(4-(1-methylvinyl)phenyl)propanone), 2-benzyl-2-dimethylamino-1-(4-morpholinophenyl)butan-1-one, 2-methyl-1-[4-(methylthio)phenyl]-2-morpholinopropan-1-one, 2-(dimethylamino)-2-[(4-methylphenyl)methyl]-1-[4-(4-morpholinyl)phenyl]-1-butanone, bis(2,4,6-trimethylbenzoyl)-phenylphosphine oxide, 2,4,6-trimethylbenzoyldiphenylphosphine oxide, (2,4,6-trimethylbenzoyl)ethoxyphenylphosphine oxide, bis(2,6-dimethoxybenzoyl)2,4,4-trimethylpentylphosphine oxide, and a derivative thereof.

The contained amount of the photoinitiator (b2) in the present adhesive composition 1 is preferably 5 parts by mass or less, more preferably 4 parts by mass or less, still more preferably 3 parts by mass or less, and particularly preferably 2 parts by mass or less with respect to 100 parts by mass of the (meth)acrylic polymer (A). The lower limit value thereof is usually 0 parts by mass.

### <Polyfunctional (Meth)Acrylate (D)>

From the viewpoint of promoting the crosslinking reaction, the present adhesive composition 1 preferably contains a polyfunctional (meth)acrylate (D). As a result, for example, even with the same light irradiation amount, the present adhesive composition 1 can quickly form the crosslinked structure. In addition, when the crosslinked structure is formed in an adhesive sheet formed of the present adhesive composition 1, it is possible to prevent adhesive overflow during storage or when being wound in a roll, and it is possible to obtain favorable adhesiveness and favorable cohesive force.

However, when the (meth)acrylic polymer (A) undergoes the hydrogen abstraction reaction by the action of the photoinitiator (B) or the like to form a sufficient crosslinked structure in the (meth)acrylic polymer (A) and/or between the (meth)acrylic polymers (A), it is not necessary to contain the polyfunctional (meth)acrylate (D).

Examples of the polyfunctional (meth)acrylate (D) include a (meth)acrylic monomer and a (meth)acrylic oligomer, each of which has two or more functional groups. These can be used alone or in combination of two or more kinds thereof.

Examples of the (meth)acrylic monomer having two or more functional groups include pentanediol di(meth)acrylate, hexanediol di(meth)acrylate, heptanediol di(meth)acrylate, octanediol di(meth)acrylate, nonanediol di(meth)acrylate, decanediol di(meth)acrylate, undecandiol di(meth)acrylate, dodecanediol di(meth)acrylate, 1,4-butanediol di(meth)acrylate, glycerin di(meth)acrylate, neopentyl glycol di(meth)acrylate, glycerin glycidyl ether di(meth)acrylate, tricyclodecanedimethacrylate, tricyclodecanedimethanol di(meth)acrylate, bisphenol A polyethoxydi(meth)acrylate, bisphenol A polypropoxydi(meth)acrylate, bisphenol F polyethoxydi(meth)acrylate, ethylene glycol di(meth)acrylate, neopentyl glycol di(meth)acrylate, trimethylolpropane trioxethyl (meth)acrylate, F-caprolactone-modified tris(2-hydroxyethyl) isocyanurate tri(meth)acrylate, pentaerythritol tri(meth)acrylate, propoxylated pentaerythritol tri(meth)acrylate, ethoxylated pentaerythritol tri(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, polypropylene glycol di(meth)acrylate, polytetramethylene glycol di(meth)acrylate, tris(acryloxyethyl) isocyanurate, dipentaerythritol hexa(meth)acrylate, dipentaerythritol penta(meth)acrylate, tripentaerythritol hexa(meth)acrylate, tripentaerythritol penta(meth)acrylate, hydroxydivaleryl neopenyl glycol di(meth)acrylate, di(meth)acrylate of a F-caprolactone adduct of hydroxydivaleryl neopenyl glycol, trimethylolpropane tri(meth)acrylate, trimethylolpropane polyethoxy tri(meth)acrylate, and ditrimethylolpropane tetra(meth)acrylate.

Examples of the polyfunctional (meth)acrylic oligomer include polyfunctional (meth)acrylic oligomers such as a polyester (meth)acrylate-based oligomer, an epoxy (meth)acrylate-based oligomer, a urethane (meth)acrylate-based oligomer, and a polyether (meth)acrylate-based oligomer.

Among the above, from the viewpoint of imparting appropriate flexibility to the cured product, (meth)acrylate-based monomer and oligomer having a glycol structure are preferable.

From the viewpoint of imparting shape stability of the adhesive sheet and durability when used for a laminate for image display devices, the contained amount of the polyfunctional (meth)acrylate (D) in the present adhesive composition 1 is preferably 0.1 parts by mass or more, more preferably 0.5 parts by mass or more, and still more preferably 1 part by mass or more with respect to 100 parts by mass of the (meth)acrylic polymer (A). In addition, from the viewpoint of maintaining the flexibility of the adhesive sheet, the upper limit thereof is preferably 20 parts by mass or less, more preferably 15 parts by mass or less, still more preferably 12 parts by mass or less, particularly preferably 10 parts by mass or less, and most preferably 5 parts by mass or less.

The lower limit and upper limit of the above-described contained amount of the polyfunctional (meth)acrylate (D) can be arbitrarily combined.

In addition, from the viewpoint of further improving the crosslinking density and improving long-term reliability, a thermal crosslinking agent can also be used in combination with the polyfunctional (meth)acrylate (D).

Examples of such a thermal crosslinking agent include an isocyanate-based crosslinking agent, an epoxy-based crosslinking agent, an aziridine-based crosslinking agent, a melamine-based crosslinking agent, an aldehyde-based crosslinking agent, an amine-based crosslinking agent, and a metal chelate-based crosslinking agent. Among the above, an isocyanate-based crosslinking agent is preferably used from the viewpoint that reactivity with the (meth)acrylic polymer (A) is excellent.

### <Other Components>

The present adhesive composition 1 can appropriately contain, as necessary, various additives such as a silane coupling agent, a plasticizer, a viscosity-imparting resin, an antioxidant, a light stabilizer, a metal inactivator, an anti-aging agent, a moisture absorbent, an anticorrosive agent, and inorganic particles as “other components”, as long as the effect of the present invention is not impaired.

In addition, a reaction catalyst such as a tertiary amine-based compound, a quaternary ammonium-based compound, and a tin laurate compound may be appropriately contained as necessary.

These can be used alone or in combination of two or more kinds thereof.

### [Silane Coupling Agent]

The silane coupling agent is an organic silicon compound containing one or more reactive functional groups and one or more alkoxy groups bonded to a silicon atom in the structure. Examples of the above-described reactive functional group include an epoxy group, a (meth)acryloyl group, a mercapto group, a hydroxyl group, a carboxy group, an amino group, an amide group, and an isocyanate group; and among these, an epoxy group or a mercapto group is preferable from the viewpoint of balance of durability.

The above-described alkoxy group bonded to a silicon atom preferably contains an alkoxy group having 1 to 8 carbon atoms, and is particularly preferably a methoxy group or an ethoxy group, from the viewpoint of durability and storage stability. The silane coupling agent may have an organic substituent other than the reactive functional group and the alkoxy group bonded to a silicon atom, for example, an alkyl group, a phenyl group, or the like.

Examples of the silane coupling agent used in the present invention include a monomer-type epoxy group-containing silane coupling agent which is a silane compound, such as 3-glycidoxypropyltrimethoxysilane, 3-glycidoxypropyltriethoxysilane, 3-glycidoxypropylmethyldiethoxysilane, 3-glycidoxypropylmethyldimethoxysilane, and 2-(3,4-epoxycyclohexyl)ethyltrimethoxysilane; an oligomer-type epoxy group-containing silane coupling agent in which a part of the silane compound is hydrolyzed and condensed or the silane compound is co-condensed with an alkyl group-containing silane compound, such as methyltriethoxysilane, ethyltriethoxysilane, methyltrimethoxysilane, and ethyltrimethoxysilane; a monomer-type mercapto group-containing silane coupling agent which is a silane compound, such as 3-mercaptopropyltrimethoxysilane, 3-mercaptopropyltriethoxysilane, γ-mercaptopropyldimethoxymethylsilane, and 3-mercaptopropylmethyldimethoxysilane; an oligomer-type mercapto group-containing silane coupling agent in which a part of the silane compound is hydrolyzed and condensed or the silane compound is co-condensed with an alkyl group-containing silane compound, such as methyltriethoxysilane, ethyltriethoxysilane, methyltrimethoxysilane, and ethyltrimethoxysilane; a (meth)acryloyl group-containing silane coupling agent such as 3-acryloxypropyltrimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane; an amino group-containing silane coupling agent such as N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane; an isocyanate group-containing silane coupling agent such as 3-isocyanatepropyltriethoxysilane; and a vinyl group-containing silane coupling agent such as vinyltrimethoxysilane and vinyltriethoxysilane.

These may be used alone or in combination of two or more kinds thereof.

Among the above, from the viewpoint of excellent durability, an epoxy group-containing silane coupling agent or a mercapto group-containing silane coupling agent is preferably used, and among these, an epoxy group-containing silane coupling agent is particularly preferable.

The contained amount of the silane coupling agent in the present adhesive composition 1 is preferably 0.005 to 10 parts by mass, more preferably 0.01 to 5 parts by mass, and particularly preferably 0.05 to 1 part by mass with respect to 100 parts by mass of the (meth)acrylic polymer (A). When the contained amount is equal to or more than the above-described lower limit value, the durability tends to be improved; and when the contained amount is equal to or less than the above-described upper limit value, the durability tends to be improved.

### [Plasticizer]

The present adhesive composition 1 can contain a plasticizer in order to impart flexibility to the adhesive sheet.

Examples of the plasticizer are not limited. Examples thereof include compounds selected from the group consisting of polyisobutylene, polyisoprene, polybutadiene, an amorphous polyolefin and a copolymer thereof, silicone, polyacrylate, oligomeric polyurethane, an ethylene propylene copolymer, and any combination or mixture thereof.

Among the above, the plasticizer is preferably polyisobutylene. Examples of the polyisobutylene plasticizer that can be used in the present specification include those commercially available from BASF under the trade name OPPANOL, in particular, those selected from OPPANOL B series.

From the viewpoint of environmental protection, a volatile organic compound (VOC) value of the plasticizer to be used is preferably smaller, and when measured by thermogravimetric analysis, it is preferably less than 1,000 ppm, more preferably less than 800 ppm, still more preferably less than 600 ppm, and most preferably less than 400 ppm.

The contained amount of the plasticizer in the present adhesive composition 1 is not particularly limited, but is preferably 0.1 to 20 parts by mass and more preferably 0.5 to 15 parts by mass or less with respect to 100 parts by mass of the (meth)acrylic polymer (A).

### [Viscosity-Imparting Agent]

The present adhesive composition 1 can contain a viscosity-imparting agent in order to improve adhesive force to the adhesive sheet.

Examples of the viscosity-imparting agent include terpene resins such as polyterpene (for example, an α-pinene-based resin, a β-pinene-based resin, and a limonene-based resin) and an aromatic modified polyterpene resin (for example, a phenol-modified terpene resin); petroleum-based resins such as a coumaran-indene resin, a C5-based hydrocarbon resin, a C9-based hydrocarbon resin, a C5/C9-based hydrocarbon resin, and a dicyclopentadiene-based resin; and rosins such as modified rosin, hydrogenated rosin, polymerized rosin, and rosin ester.

The contained amount of the viscosity-imparting agent in the present adhesive composition 1 is not particularly limited, but is preferably 0.1 to 20 parts by mass and more preferably 0.5 to 15 parts by mass or less with respect to 100 parts by mass of the (meth)acrylic polymer (A).

### [Anticorrosive Agent]

The present adhesive composition 1 can contain an anticorrosive agent in order to prevent corrosion when the adherend includes a portion having corrosiveness, such as a metal wire.

Examples of the anticorrosive agent include triazoles and benzotriazoles.

The contained amount of the anticorrosive agent in the present adhesive composition 1 is preferably 0.01 to 5 parts by mass and more preferably 0.1 to 3 parts by mass or less with respect to 100 parts by mass of the (meth)acrylic polymer (A).

A method of preparing the present adhesive composition 1 is not particularly limited. For example, the present adhesive composition 1 is prepared by mixing predetermined amounts of the (meth)acrylic polymer (A), the photoinitiator (b1), and, as necessary, the photoinitiator (b2), the polyfunctional (meth)acrylate (D), and other components such as the silane coupling agent.

The adhesive composition thus obtained is suitably used for an adhesive sheet, particularly an adhesive sheet used for bonding an optical member.

The present adhesive composition 1 may be syrup. A syrup component at this time may be composed of an acrylic polymer and a monomer component. In an example, such a syrup component may be formed by so-called partial polymerization, or may be prepared by adding a monomer to a polymer in which a monomer constituting the (meth)acrylic polymer (A) is completely polymerized or partially polymerized. That is, when a predetermined monomer composition is partially polymerized, some of the monomers are polymerized to form an oligomer or a polymer, and some of the monomers remain, whereby the syrup component can be formed. In addition, in another example, the composition can also be made syrupy by adding a monomer component to the partially polymerized or fully polymerized polymer.

Therefore, the constitutional unit derived from the monomer constituting the (meth)acrylic polymer (A) in the present specification may refer to a monomer present in a state in which an oligomer or a polymer is formed in the components of the acrylic polymer, or a monomer contained in the syrup component before polymerization.

### 2. Second Embodiment

An adhesive composition according to a second embodiment of the present invention (hereinafter, referred to as “present adhesive composition 2”) contains a (meth)acrylic polymer (A), a photoinitiator (B), and an ultraviolet absorber (C), in which the photoinitiator (B) includes a photoinitiator (b1) having a glyoxylate structure and a molar absorption coefficient at a wavelength of 405 nm of 30 (L/mol·cm) or more. The aspect of the present adhesive composition 2 is the same as that of the present adhesive composition 1 according to the first embodiment, except that the ultraviolet absorber (C) is contained.

The present adhesive composition 2 can be suitably used for bonding an optical member.

### <Ultraviolet Absorber (C)>

The present adhesive composition 2 contains an ultraviolet absorber (C). The image display constituent member is usually easily deteriorated by ultraviolet rays, but by using the adhesive sheet formed of the present adhesive composition 2 containing the ultraviolet absorber (C), it is easy to prevent the deterioration of the image display constituent member due to light.

Since the present adhesive composition 2 contains the ultraviolet absorber (C), in photocuring, it is preferable to cure the composition with active energy ray having a wavelength other than an absorption wavelength of the ultraviolet absorber (C).

Examples of the ultraviolet absorber (C) include a benzophenone-based ultraviolet absorber, a benzotriazole-based ultraviolet absorber, a triazine-based ultraviolet absorber, a salicylic acid-based ultraviolet absorber, and a cyanoacrylate-based ultraviolet absorber. These ultraviolet absorbers can be used alone or in combination of two or more kinds thereof.

Examples of the above-described benzophenone-based ultraviolet absorber include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydrate benzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodium sulfoxybenzophenone, bis(5-benzoyl-4-hydroxy-2-methoxyphenyl)methane, 2-hydroxy-4-n-dodecyloxybenzophenone, and 2-hydroxy-4-methoxy-2′-carboxybenzophenone.

Examples of the above-described benzotriazole-based ultraviolet absorber include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylene bis[4-(1,1,3,3-tetramethylbutyl)-6-(2H-benzotriazole-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylene bis(4-cumyl-6-benzotriazole phenyl), and 2,2′-p-phenylene bis(1,3-benzoxazine-4-one, 2-[2-hydroxy-3-(3,4,5,6-tetrahydrophthalimidomethyl)-5-methylphenyl]benzotriazole.

Examples of the above-described triazine-based ultraviolet absorber include 2-(2-hydroxy-4-methoxyphenyl)-4,6-diphenyl-1,3,5-triazine, 2-(2-hydroxy-4-ethoxyphenyl)-4,6-diphenyl-1,3,5-triazine, 2-(2-hydroxy-4-propoxyphenyl)-4,6-diphenyl-1,3,5-triazine, 2-(2-hydroxy-4-butoxyphenyl)-4,6-diphenyl-1,3,5-triazine, 2-(2-hydroxy-4-hexyloxyphenyl)-4,6-diphenyl-1,3,5-triazine, 2-(2-hydroxy-4-octyloxyphenyl)-4,6-diphenyl-1,3,5-triazine, 2-(2-hydroxy-4-dodecyloxyphenyl)-4,6-diphenyl-1,3,5-triazine, 2-(2-hydroxy-4-benzyloxyphenyl)-4,6-diphenyl-1,3,5-triazine, 2,4-bis(2-hydroxy-4-butoxyphenyl)-6-(2,4-dibutoxyphenyl)-1,3-5-triazine, 2,4,6-tris(2-hydroxy-4-hexyloxy-3-methylphenyl)-1,3,5-triazine, 2-(2-hydroxy-4-[1-octyloxycarbonylethoxy]phenyl)-4,6-bis(4-phenylphenyl)-1,3,5-triazine, 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2,4-dimethylphenyl)-6-[2-hydroxy-4-(3-octyloxy-2-hydroxypropyloxy)-5-α-cumylphenyl]-s-triazine, 2,4-bis(2,4-dimethylphenyl)-6-[2-hydroxy-4-(3-nonyloxy-2-hydroxypropyloxy)-5-α-cumylphenyl]-s-triazine, 2,4-bis(2,4-dimethylphenyl)-6-[2-hydroxy-4-(3-decyloxy-2-hydroxypropyloxy)-5-α-cumylphenyl]-s-triazine, and 2-(2-hydroxy-4-acryloyloxyethoxyphenyl)-4,6-bis(2,4-dimethylphenyl)-1,3,5-triazine.

Examples of the above-described salicylic acid-based ultraviolet absorber include phenyl salicylate, p-tert-butylphenyl salicylate, and p-octylphenyl salicylate.

Examples of the above-described cyanoacrylate-based ultraviolet absorber include 2-ethylhexyl-2-cyano-3,3′-diphenyl acrylate and ethyl-2-cyano-3,3′-diphenyl acrylate.

Among the above, from the viewpoint of effectively suppressing light reaching the image display device constituent member, a benzophenone-based ultraviolet absorber, a benzotriazole-based ultraviolet absorber, or a triazine-based ultraviolet absorber is preferable. In addition, among the above, from the viewpoint of excellent yellowing resistance, a benzophenone-based ultraviolet absorber and a triazine-based ultraviolet absorber are more preferable. In addition, from the viewpoint of blocking rays up to a long wavelength range, an ultraviolet absorber having absorption in a wavelength range longer than 400 nm is preferable.

Examples of a commercially available product of the ultraviolet absorber include “Tinosorb S” manufactured by BASF Japan Ltd., “KEMISORB 111” manufactured by CHEMIPRO KASEI, and “CONFOGUARD UV002” manufactured by FUJIFILM Corporation.

From the viewpoint of improving light fast reliability, a lower limit value of the contained amount of the ultraviolet absorber (C) in the present adhesive composition 2 is preferably 0.1 parts by mass or more, more preferably 0.2 parts by mass or more, still more preferably 0.5 parts by mass or more, particularly preferably 1 part by mass or more, and particularly preferably 1.5 parts by mass or more with respect to 100 parts by mass of the (meth)acrylic polymer (A). On the other hand, from the viewpoint of suppressing bleed-out and suppressing the coloration, an upper limit value of the contained amount of the ultraviolet absorber (C) is preferably 15 parts by mass or less, more preferably 12 parts by mass or less, still more preferably 10 parts by mass or less, particularly preferably 8 parts by mass or less, especially preferably 5 parts by mass or less, and most preferably 3 parts by mass or less with respect to 100 parts by mass of the (meth)acrylic polymer (A).

A method of preparing the present adhesive composition 2 is not particularly limited. For example, the present adhesive composition is prepared by mixing predetermined amounts of the (meth)acrylic polymer (A), the photoinitiator (b1), the ultraviolet absorber (C), and, as necessary, the photoinitiator (b2), the polyfunctional (meth)acrylate (D), and other components such as the silane coupling agent.

The adhesive composition thus obtained is suitably used for an adhesive sheet, particularly an adhesive sheet used for bonding an optical member.

The present adhesive composition 2 may be syrup as in the present adhesive composition 1.

<<Adhesive sheet>>

An adhesive sheet according to the embodiment of the present invention (hereinafter, also referred to as “present adhesive sheet”) is an adhesive sheet having an adhesive layer formed of the present adhesive composition 1 or the present adhesive composition 2. The present adhesive sheet is particularly useful as an adhesive sheet for organic EL display devices.

The present adhesive sheet may be a monolayer sheet consisting of only an adhesive layer (hereinafter, also referred to as “present adhesive layer”) formed of the present adhesive composition 1 or the present adhesive composition 2, or may be a multilayer sheet in which a plurality of the present adhesive layers are laminated.

### <Physical Properties of Present Adhesive Sheet>

The present adhesive sheet can have the following physical properties.

### [Gel Fraction (X0)]

A gel fraction (X0) of the present adhesive sheet is preferably 20% or more. When the gel fraction of the present adhesive sheet is equal to or more than the lower limit value, the shape can be easily maintained. From such a viewpoint, the above-described gel fraction (X0) is more preferably 25% or more, still more preferably 30% or more, and particularly preferably 35% or more.

In addition, from the viewpoint of obtaining flexibility, the gel fraction (X0) of the present adhesive sheet is preferably 90% or less, more preferably 80% or less, still more preferably 70% or less, even more preferably 60% or less, even still more preferably 55% or less, and particularly preferably 50% or less.

The above-described lower limit and upper limit of the above-described gel fraction (X0) can be arbitrarily combined.

The above-described gel fraction (X0) is a guideline for the degree of crosslinking (curing degree), and can be measured under measurement conditions described in Examples later.

The present adhesive sheet preferably has active energy ray curability. Here, the “adhesive sheet has active energy ray curability” means that the adhesive sheet has a property of being cured by active energy ray, and in other words, that the adhesive sheet has room to be cured by active energy ray.

The present adhesive sheet may be an adhesive sheet that has been cured (hereinafter, also referred to as “primary cured”) in a state in which the present adhesive composition 1 or the present adhesive composition 2 is left to be cured with active energy ray, or an adhesive sheet in which the present adhesive composition 1 or the present adhesive composition 2 is crosslinked (primary cured) by a thermal crosslinking agent and can be cured with active energy ray. The primary-cured adhesive sheet can be cured by irradiating active energy ray before or after being bonded to an adherend (hereinafter, also referred to as “secondary cured”).

When the present adhesive sheet has active energy ray curability, “gel fraction (X0)” means a gel fraction of the pressure-sensitive adhesive sheet in a state of being subjected to primary curing.

When the present adhesive sheet is subjected to the primary curing, the primary curing may be carried out by heat or by active energy ray, but from the viewpoint of easily controlling the gel fraction (X0) within the predetermined range, an adhesive sheet which has been subjected to the primary curing by irradiation with active energy ray is preferable.

The active energy ray used for the primary curing is preferably an active energy ray having a wavelength longer than 380 nm, and more preferably an active energy ray having a wavelength longer than 400 nm.

When the present adhesive sheet is subjected to the primary curing with active energy ray, for example, the primary curing is preferably carried out by irradiation with an active energy ray at 405 nm with an integrated irradiation amount of 10 to 4,000 mJ/cm². In such active energy ray irradiation, the irradiation amount is preferably 50 mJ/cm² or more and 3,500 mJ/cm² or less, more preferably 100 mJ/cm² or more and 3,000 mJ/cm² or less, particularly preferably 200 mJ/cm² or more and 2,500 mJ/cm² or less, and even more preferably 300 mJ/cm² or more and 2000 mJ/cm² or less. When the irradiation amount is within the above-described range, the curing degree can be adjusted while leaving room for curing, which is preferable.

The above-described active energy ray irradiation amount is a total of integrated energy on one side and integrated energy on the other side when the active energy ray is irradiated from both sides.

### [Gel Fraction (X1)]

When the present adhesive sheet has active energy ray curability, a gel fraction (X1) after irradiating the adhesive sheet with an active energy ray having a wavelength of 405 nm such that an integrated light amount is 2,000 to 4,000 mJ/cm² (after the secondary curing) is preferably 30% or more, more preferably 40% or more, still more preferably 50% or more, and particularly preferably 60% or more.

When the gel fraction (X1) after the secondary curing is 30% or more, a laminate for image display devices, using the present adhesive sheet, has excellent durability.

In addition, a difference (X1−X0) between the above-described gel fraction (X1) after the secondary curing and the above-described gel fraction (X0) in a state before the active energy ray irradiation (before the secondary curing), that is, in the primary curing state is preferably 2% or more, more preferably 10% or more, still more preferably 15% or more, and particularly preferably 20% or more. When the difference (X1−X0) is equal to or more than the above-described lower limit value, it is possible to achieve both adhesiveness to the member when the present adhesive sheet is bonded to the image display device constituent member and durability of the laminate for image display devices after bonding at a higher level.

The above-described gel fraction (X1) can be measured by a method described in Examples later.

### [Adhesive Force]

In the present adhesive sheet, an adhesive force with respect to soda-lime glass at a peeling angle of 1800 and a peeling rate of 60 mm/min is preferably 3.0 N/cm or more, more preferably 4.0 N/cm or more, and still more preferably 5.0 N/cm or more.

### [Post-Curing Adhesive Force]

When the present adhesive sheet has active energy ray curability and the present adhesive sheet is bonded to soda-lime glass and then irradiated with an active energy ray having a wavelength of 405 nm with an integrated light amount of 2,000 to 4,000 mJ/cm², it is preferable that an adhesive force (post-curing adhesive force) with respect to the soda-lime glass at a peeling angle of 180° and a peeling rate of 60 mm/min be higher than the above-described adhesive force.

Specifically, the post-curing adhesive force is preferably 5.0 N/cm or more, more preferably 6.0 N/cm or more, and still more preferably 7.0 N/cm or more. When the post-curing adhesive force is 5.0 N/cm or more, a laminate for image display devices, using the present adhesive sheet, has excellent durability.

### [Chromaticity]

When the present adhesive sheet is irradiated with an active energy ray having a wavelength of 405 nm with an integrated light amount of 2,000 to 4,000 mJ/cm², a chromaticity (b*1) is preferably 2.5 or less, more preferably 2.0 or less, still more preferably 1.5 or less, and particularly preferably 1.0 or less.

In the present adhesive sheet, a difference (b*1−b*0) between the chromaticity (b*1) after the above-described active energy ray irradiation and a chromaticity (b*0) before the above-described active energy ray irradiation is preferably 1.0 or less, more preferably 0.5 or less, still more preferably 0.1 or less, and particularly preferably 0 or less.

When (b*1) and (b*1−b*0) satisfy the above-described ranges, an adhesive sheet in which yellowing due to irradiation with active energy rays is suppressed can be obtained.

The chromaticity (b*1) and the chromaticity (b*0) described above can be measured by a method described in Examples later.

The photoinitiator having high photosensitivity to light in a long wavelength range generally has a problem of being easily colored. However, since the acylphosphine oxide-based photoinitiator has a photobleaching effect, it has been widely used for applications where the coloration is a concern. However, this is an effect of the cleavage-type photoinitiator being decomposed after the photoreaction, and it is considered that there is no photobleaching effect in the hydrogen abstraction-type photoinitiator which does not undergo photodecomposition.

Surprisingly, it is found that, by using the photoinitiator (b1), although the photoinitiator (b1) is the hydrogen abstraction-type photoinitiator, not only does yellowing not occur after the irradiation with light, but the photobleaching effect can also be obtained. The present adhesive sheet can be suitably used for applications for an image display device because the present adhesive sheet not only does not generate photodecomposition products but also has excellent active energy ray curability and color fastness while having ultraviolet absorbability.

### [Light Transmittance]

The light transmittance of the present adhesive sheet at a wavelength of 380 nm is preferably 10% or less. By having such optical characteristics, it is easy to protect the image display device constituent member from deterioration due to ultraviolet rays. From such a viewpoint, the above-described light transmittance is more preferably 7% or less, still more preferably 5% or less, and particularly preferably 3% or less.

The light transmittance of the present adhesive sheet at a wavelength of 400 nm is preferably 30% or less. By having such optical characteristics, even an image display device constituent member which is likely to be deteriorated by light can be firmly protected from incident light. From such a viewpoint, the above-described light transmittance is more preferably 20% or less, still more preferably 10% or less, and particularly preferably 5% or less.

The above-described light transmittance can be measured by a method described in Examples later.

### [Total Light Transmittance and Haze]

The total light transmittance of the present adhesive sheet is preferably 80% or more, more preferably 85% or more, and still more preferably 90% or more.

The above-described total light transmittance can be measured by a method described in Examples later.

The haze of the present adhesive sheet is preferably 1.0% or less, more preferably 0.8% or less, and still more preferably 0.5% or less. When the haze of the present adhesive sheet is 1.0% or less, the present adhesive sheet can be used as an adhesive sheet for image display devices, which requires transparency.

The above-described haze can be measured with a haze meter.

In order to make the haze of the present adhesive sheet within the above-described range, it is preferable that the present adhesive sheet not contain particles such as organic particles.

### <Thickness>

A thickness of the present adhesive sheet is not particularly limited; but when the thickness is 10 μm or more, handleability is favorable, and when the thickness is 1,000 μm or less, the present adhesive sheet can be made thinner. From such a viewpoint, the thickness of the present adhesive sheet is preferably 10 μm or more, more preferably 15 μm or more, still more preferably 20 μm or more, and particularly preferably 25 μm or more. On the other hand, the upper limit thereof is preferably 1,000 μm or less, more preferably 500 μm or less, still more preferably 400 μm or less, particularly preferably 300 μm or less, and most preferably 250 μm or less.

### <Method of Manufacturing Present Adhesive Sheet>

Next, a method of manufacturing the present adhesive sheet will be described.

However, the following description is an example of the method of manufacturing the present adhesive sheet, and the present adhesive sheet is not limited to those manufactured by such a manufacturing method.

The present adhesive sheet may be manufactured, for example, by preparing the present adhesive composition 1, molding the present adhesive composition 1 into a sheet shape, curing the present adhesive composition 1 by crosslinking, that is, by polymerization reaction, and appropriately processing the sheet as necessary. In addition, the present adhesive sheet may be formed by preparing the present adhesive composition 1, coating a member for constituting an image display device with the present adhesive composition 1, and curing the present adhesive composition 1.

The same applies when the present adhesive composition 2 is used.

When preparing the present adhesive composition 1 or the present adhesive composition 2, the above-described raw materials may be mixed using a propeller type stirrer or a kneader (for example, a uniaxial extruder, a biaxial extruder, a planetary mixer, a biaxial mixer, a pressurized kneader, or the like).

When mixing various raw materials, various additives such as a silane coupling agent and an antioxidant may be supplied to the stirrer or the kneader after being blended with a resin in advance, all materials may be supplied after being melted and mixed in advance, or a master batch in which only the additives are concentrated in a resin in advance may be prepared and supplied.

As a method of molding the present adhesive composition 1 or the present adhesive composition 2 into a sheet shape, a known method, for example, a wet lamination method, a dry lamination method, an extrusion casting method using a T-die, an extrusion lamination method, a calender method, an inflation method, injection molding, a liquid injection curing method, or the like can be adopted. Among the above, when manufacturing a sheet, a wet lamination method, an extrusion casting method, or an extrusion lamination method is suitable.

The curing of the present adhesive composition 1 or the present adhesive composition 2 can be carried out by irradiating with active energy rays, and the present adhesive sheet can be manufactured by irradiating a molded body of the present adhesive composition 1, for example, a molded body formed into a sheet body, with active energy rays. In addition to the irradiation with active energy rays, the adhesive composition can be further cured by heating.

The irradiation energy, the irradiation time, the irradiation method, and the like of the active energy ray are not particularly limited, and a photopolymerization initiator may be activated to crosslink the present adhesive composition 1 or the present adhesive composition 2.

Examples of the active energy ray in the above-described active energy ray irradiation include rays such as far ultraviolet rays, ultraviolet rays, near ultraviolet rays, infrared rays, and visible rays; and ionizing radiation such as X-rays, α-rays, β-rays, γ-rays, electron beams, proton beams, and neutron beams. Among the above, ultraviolet rays or visible rays are suitable from the viewpoint of suppressing damage to the image display device constituent member and easily controlling the reaction. In addition, curing by ultraviolet irradiation or visible light irradiation is advantageous from the viewpoint of curing speed, ease of obtaining an irradiation device, cost, and the like. Among the above, from the viewpoint of preventing curing inhibition by the ultraviolet absorber, curing with visible rays, for example, with an active energy ray of 405 nm is preferable.

Examples of a light source for the active energy ray irradiation include a high-pressure mercury lamp, an ultra-high pressure mercury lamp, a low-pressure mercury lamp, a carbon arc lamp, a metal halide lamp, a xenon lamp, a chemical lamp, an inductively coupled plasma lamp, and an LED, each of which emits light in a wavelength range of 150 to 450 nm.

From the viewpoint of curing, an irradiation amount (integrated light amount) of the active energy ray is preferably 10 to 6,000 mJ/cm², more preferably 50 mJ/cm² to 5,500 mJ/cm², still more preferably 100 mJ/cm² to 5,000 mJ/cm², particularly preferably 200 mJ/cm² to 4,000 mJ/cm², and most preferably 300 mJ/cm² to 3,000 mJ/cm².

As another embodiment of the method of manufacturing the present adhesive sheet, the present adhesive sheet can also be manufactured by dissolving the adhesive composition in an appropriate solvent and using various coating methods. When the adhesive composition is syrup, it is also possible to perform coating without using a solvent.

When a coating method is used, the present adhesive sheet can also be obtained by heat-curing in addition to curing by the above-described active energy ray irradiation. In the coating, the thickness of the present adhesive sheet can be adjusted by a coating thickness and a concentration of solid contents of a coating liquid.

For example, the present adhesive sheet can be formed by dissolving the adhesive composition in a solvent, coating a mold release film with the coating liquid, drying the coating liquid, and curing the coating liquid with active energy rays. Furthermore, a mold release film may be laminated as necessary. In this case, the mold release film may be coated, dried, and cured by irradiation with active energy rays, and then a mold release film may be laminated thereon to form the present adhesive sheet, or the mold release film may be coated, dried, and laminated, and then cured by irradiation with active energy rays to form the present adhesive sheet.

The solvent is not particularly limited as long as it dissolves the present adhesive composition 1 or the present adhesive composition 2, and examples thereof include ester-based solvents such as methyl acetate, ethyl acetate, butyl acetate, methyl acetoacetate, and ethyl acetoacetate; ketone-based solvents such as acetone, methyl ethyl ketone, and methyl isobutyl ketone; aromatic solvents such as toluene and xylene; and alcohol-based solvents such as methanol, ethanol, and propyl alcohol. These can be used alone or in combination of two or more kinds thereof. Among the above, ethyl acetate, acetone, methyl ethyl ketone, or toluene is preferable from the viewpoint of solubility, drying properties, cost, and the like; and ethyl acetate is particularly suitably used.

From the viewpoint of drying properties, an amount of the solvent used is preferably 600 parts by mass or less, more preferably 500 parts by mass or less, still more preferably 400 parts by mass or less, and particularly preferably 300 parts by mass or less with respect to 100 parts by mass of the (meth)acrylic polymer (A). On the other hand, the amount is preferably 1 part by mass or more, more preferably 50 parts by mass or more, still more preferably 100 parts by mass or more, and particularly preferably 150 parts by mass or more.

The coating method can be a commonly used method such as roll coating, die coating, gravure coating, comma coating, screen printing, and bar coating.

The contained amount of the solvent in the adhesive composition after the above-described drying is preferably 1% by mass or less, more preferably 0.5% by mass or less, particularly preferably 0.1% by mass or less, and most preferably 0% by mass.

A drying temperature is usually 40° C. to 150° C., more preferably 45° C. to 140° C., still more preferably 50° C. to 130° C., and particularly preferably 55° C. to 120° C. In the above-described temperature range, the solvent can be removed efficiently and relatively stably while suppressing thermal deformation of the mold release film.

A drying time is usually 1 to 30 minutes, more preferably 3 to 25 minutes, and still more preferably 5 to 20 minutes. In the above-described time range, the solvent can be efficiently and sufficiently removed.

Examples of the drying method include drying with a dryer, drying with a heat roll, and drying with hot air blown to the film. Among the above, a dryer is preferable from the viewpoint that the drying can be performed uniformly and easily. These can be used alone or in combination of two or more kinds thereof.

<<Adhesive Sheet Equipped with Mold Release Film>>

The present adhesive sheet can also be provided as an adhesive sheet equipped with a mold release film (adhesive sheet laminate) by laminating a mold release film on one or both surfaces of the present adhesive sheet.

When the mold release film is provided on both surfaces of the present adhesive sheet, it is preferable to adopt a laminate configuration in which a lightly peeling film having a relatively low peeling force and a heavily peeling film having a relatively high peeling force are laminated. When the adhesive sheet equipped with a mold release film, having mold release films on both surfaces, is used, first, one release film (lightly peeling film) is peeled off to expose one surface of the adhesive sheet, the adhesive sheet is bonded to an image display device constituent member (referred to as a first member), and the other mold release film (heavily peeling film) is peeled off to bond the other surface of the exposed adhesive sheet to another image display device constituent member (referred to as a second member).

As such a mold release film, a known mold release film can be appropriately used.

As a material of the mold release film, for example, a peeling-treated product obtained by applying a mold release agent such as a silicone resin to a film such as a polyester film, a polyolefin film, a polycarbonate film, a polystyrene film, an acrylic film, a triacetyl cellulose film, and a fluororesin film, or a release paper can be appropriately selected and used. Among the above, a polyester film, specifically, a polyethylene terephthalate (PET) film, particularly a biaxially stretched PET film is preferable from the viewpoint of excellent transparency, mechanical strength, heat resistance, flexibility, and the like. A mold release film in which a release layer obtained by curing a curable silicone-based release agent containing a silicone resin as a main component is provided on the above-described base material can be used.

A thickness of the mold release film is not particularly limited. For example, from the viewpoint of workability and handleability, the thickness is preferably 10 to 250 m, more preferably 25 to 200 μm, and still more preferably 35 to 190 μm.

### <Preferred Use of Present Adhesive Sheet>

The present adhesive sheet is suitably used for bonding an optical member. Specifically, the present adhesive sheet is used as a member constituting a display, in particular, as a member for bonding a member used for producing a display; and is used as an adhesive sheet for bonding an image display panel and an image display device constituent member such as a protective panel and a touch panel disposed on a front surface side (visible side) of the image display panel, or a member constituting the image display device constituent member.

The same components as described below can be used as the image display device constituent member.

### <<Laminate for Image Display Devices>>

A laminate for image display devices according to an example of an embodiment of the present invention (hereinafter, also referred to as “present laminate for image display devices”) is a laminate for image display devices, in which two image display device constituent members are laminated through the present adhesive sheet. It is preferable that the present laminate for image display devices have a configuration in which two image display device constituent members are laminated through the present adhesive sheet.

Among the components of the present laminate for image display devices, the present adhesive sheet is as described above, and the components other than the adhesive sheet will be described below.

### <Image Display Device Constituent Member>

Examples of the image display device constituent member constituting the present laminate for image display devices include a flat panel image display device constituent member and a flexible image display device constituent member. Examples of such an image display device constituent member include a liquid crystal display, a flexible display such as an organic electroluminescence (EL) display, a cover lens (cover film), a polarizing plate, a polarizer, a phase difference film, a barrier film, a viewing angle compensation film, a brightness improvement film, a contrast improvement film, a diffusion film, a semi-transmissive reflective film, an electrode film, a transparent conductive film, a metal mesh film, and a touch sensor film. Any one or two of these may be used in combination. For example, a combination of the flexible display and other image display device constituent members, or a combination of the cover lens and other image display device constituent members can be used.

The flexible image display device constituent member means a member which is a bendable member and used for an image display device having a curved surface shape, or a member which is repeatedly bendable. In particular, it is preferable that the flexible image display device constituent member be a member that can be fixed to a curved shape having a curvature radius of 25 mm or more, and particularly preferably a member that can withstand a bending action with a curvature radius of less than 25 mm, more preferably a curvature radius of less than 3 mm.

In the above-described configuration, examples of the member constituting the image display device constituent member include a resin sheet and glass.

Examples of a material of the resin sheet include a polyester resin, a cycloolefin resin, a triacetyl cellulose resin, a polymethyl methacrylate resin, a polyurethane, an epoxy resin, a polyimide resin, and an aramid resin. The material may be one kind of resin or two or more kinds of resins. Among the above, a resin sheet containing, as a main component, at least one resin selected from the group consisting of a polyester resin, a cycloolefin resin, a triacetyl cellulose resin, a polymethyl methacrylate resin, an epoxy resin, a polyimide resin, an aramid resin, and a polyurethane resin is preferable.

Here, the “main component” refers to a component which occupies the highest weight ratio among the components constituting the image display device constituent member; and specifically, the main component occupies 50% by mass or more of the resin composition (resin sheet) forming the image display device constituent member, and further, it is preferable that the main component occupy 55% by mass or more, particularly 60% by mass or more.

### <Method of Manufacturing Present Laminate for Image Display Devices>

The method of manufacturing the present laminate for image display devices is not particularly limited, and for example, as described above, the adhesive composition may be applied onto the image display device constituent member to form an adhesive sheet, or an adhesive sheet equipped with a mold release film may be formed in advance and then bonded to the image display device constituent member.

### <<Image Display Device>>

An image display device according to an example of an embodiment of the present invention (hereinafter, also referred to as “present image display device”) is an image display device obtained by incorporating the laminate for image display devices, having a configuration in which two image display device constituent members are bonded to each other through the present adhesive sheet. For example, the laminate for image display devices, having a configuration in which two image display device constituent members are bonded to each other through the present adhesive sheet, can be laminated on another image display device constituent member to form the present adhesive sheet image display device including the laminate.

### EXAMPLES

Hereinafter, an example of an embodiment of the present invention will be described in detail. However, the present invention is not limited to the embodiment described below.

First, details of raw materials of adhesive compositions prepared in Examples will be described.

<(Meth)Acrylic Polymer (a)>
(Meth)acrylic polymer (A-1): acrylic copolymer obtained by random copolymerization of 46.4 parts by mass of 2-ethylhexyl acrylate, 45.1 parts by mass of methyl acrylate, and 8.5 parts by mass of N-vinyl-2-pyrrolidone (weight-average molecular weight: approximately 230,000)
(Meth)acrylic polymer (A-2): acrylic copolymer obtained by random copolymerization of 64.0 parts by mass of 2-ethylhexyl acrylate, 19.0 parts by mass of methyl acrylate, and 17.0 parts by mass of hydroxyethyl acrylate (weight-average molecular weight: approximately 460,000)

### <Photoinitiator (B)>

Photoinitiator (b1-1): photoinitiator having a glyoxylate structure represented by Formula 3-1 (molar absorption coefficient at a wavelength of 405 nm: 3.3×10² L/mol·cm)

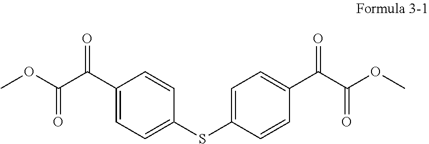

Photoinitiator (b2-1): mixture of 2,4,6-trimethylbenzophenone and 4-methylbenzophenone (“Esacure TZT” manufactured by IGM Resins; molar absorption coefficient at a wavelength of 405 nm: 0 L/mol·cm) Photoinitiator (b2-2): methylbenzoylformate (“Omnirad MBF” manufactured by IGM Resins; molar absorption coefficient at a wavelength of 405 nm: 6.5 L/mol·cm) Photoinitiator (b2-3): 2,4-diethylthioxanthone (“Omnirad DETX” manufactured by IGM Resins; molar absorption coefficient at a wavelength of 405 nm: 3.3×10³ L/mol·cm)
Photoinitiator (b2-4): ethyl(2,4,6-trimethylbenzoyl)-phenylphosphinate (“Omnirad TPO-L” manufactured by IGM Resin; molar absorption coefficient at a wavelength of 405 nm: 81 L/mol·cm)

### <Ultraviolet Absorber (C)>

Ultraviolet absorber (C-1): bisethylhexyloxyphenol methoxyphenyltriazine (Tinosorb S, manufactured by BASF Japan Ltd.)

### <Polyfunctional (Meth)Acrylate (D)>

Polyfunctional (meth)acrylate (D-1): polypropylene glycol #400 diacrylate (NK ESTER APG-400, manufactured by Shin-Nakamura Chemical Co., Ltd.)
Polyfunctional (meth)acrylate (D-2): propylene oxide-modified pentaerythritol tri(tetra)acrylate (NK ESTER ATM-4PL, manufactured by Shin-Nakamura Chemical Co., Ltd.) Polyfunctional (meth)acrylate (D-3): pentaerythritol tri(tetra)acrylate (NK ESTER ATMM3L, manufactured by Shin-Nakamura Chemical Co., Ltd.)

### Example A1

100 parts by mass of the (meth)acrylic polymer (A-1) and 1.5 parts by mass of the photoinitiator (B-1) were uniformly mixed to produce an adhesive composition.

The above-described adhesive composition was developed in a sheet shape on a mold release film (PET film manufactured by Mitsubishi Chemical Corporation) having a thickness of 100 μm, which had been subjected to a silicone release treatment, such that the thickness was 100 μm.

Next, a silicone release-treated mold release film having a thickness of 75 μm (PET film manufactured by Mitsubishi Chemical Corporation) was laminated on the sheet-like adhesive composition to form a laminate, thereby obtaining an adhesive sheet equipped with a mold release film, consisting of a mold release film/adhesive sheet/mold release film.

Next, using a 405 nm LED light source (FireJet FJ200 405 nm), both surfaces of the adhesive sheet equipped with a mold release film were irradiated with light having a peak wavelength of 405 nm through the mold release film with an irradiation amount of 1,000 mJ/cm² on both surfaces, and thus the adhesive sheet was semi-cured. The integrated light amount was measured using an ultraviolet light integrator “UIT-250” (manufactured by Ushio Inc.) and a light receiver “UVD-C405” (manufactured by Ushio Inc.) (the same applies hereinafter).

The obtained adhesive sheet equipped with a mold release film included an adhesive sheet having active energy ray curability.

### Example A2 and Comparative Examples A1 to 4

An adhesive sheet equipped with a mold release film was produced in the same manner as in Example A1, except that the formulation of the adhesive composition was changed as shown in Table 1.

### [Measurement and Evaluation of Physical Properties]

The adhesive sheets produced in Examples and Comparative Examples were subjected to the following various measurements and evaluations. The evaluation results are summarized in Tables 1 and 2.

### <Gel Fraction>

From the adhesive sheet equipped with a mold release film, from which the mold release film had been peeled off, approximately 0.1 g of an adhesive sheet piece was collected for the adhesive sheet equipped with a mold release film produced in Examples and Comparative Examples. The collected adhesive sheet piece was wrapped in an SUS mesh (#150) having a mass X (g) in advance in a bag shape, the mouth of the bag was closed to prepare a sample, and a mass Y (g) of the sample was measured. The above-described sample was stored at 23° C. in the dark for 24 hours in a state of being immersed in ethyl acetate, the sample was taken out and heated at 70° C. for 4.5 hours to evaporate ethyl acetate, and a mass Z (g) of the dried sample was measured. From each of the measured masses, a gel fraction (X0) after the primary curing was calculated according to the following expression.

$$Gel fraction ( \% ) = [ ( Z - X ) / ( Y - X ) ] \times 100$$

In addition, the adhesive sheet equipped with a mold release film produced in Examples and Comparative Examples was irradiated with light having a peak wavelength of 405 nm through the mold release film using a 405 nm LED light source (FireJet FJ200 405 nm) with an integrated light amount of 3,000 mJ/cm², thereby curing the adhesive sheet. Using the adhesive sheet after curing, a gel fraction (X1) after the secondary curing was calculated in the same manner as the gel fraction (X0).

### <Chromaticity>

The release film of the adhesive sheet equipped with a mold release film produced in Examples and Comparative Examples was peeled off, and a bonded sample was prepared by sandwiching the exposed adhesive surfaces with two soda-lime glass (thickness: 0.55 mm). For the bonded sample, using a spectrophotometer (Suga Test Instruments Co., Ltd.) “SC-T”, a chromaticity (b*0) after the primary curing was measured with a D65 light source and a visual field of 100 based on the method of JIS K 7103.

In addition, the adhesive sheet equipped with a mold release film produced in Examples and Comparative Examples was irradiated with light having a peak wavelength of 405 nm through the mold release film using a 405 nm LED light source (FireJet FJ200 405 nm) with an integrated light amount of 3,000 mJ/cm², thereby curing the adhesive sheet. Using the adhesive sheet after the curing, a chromaticity (b*1) after the secondary curing was measured in the same manner as the chromaticity (b*0).

When the chromaticity (b*1) after the secondary curing was 2.5 or less, it was determined that there was no problem in practical use.

### <Light Transmittance>

One mold release film of the adhesive sheet equipped with a mold release film produced in Examples and Comparative Examples was peeled off, and the exposed adhesive surface was roll-pressed to soda-lime glass (82 mm×53 mm×0.5 mm (thickness)). Next, the remaining mold release film was peeled off, and the exposed adhesive surface was roll-pressed to another soda-lime glass (82 mm×53 mm×0.5 mm (thickness)). Thereafter, the laminate was subjected to an autoclave treatment (60° C., gauge pressure: 0.2 MPa, 20 minutes) to finish bonding, and irradiated with light having a peak wavelength of 405 nm using a 405 nm LED light source (FireJet FJ200 405 nm) with an integrated light amount of 3,000 mJ/cm², thereby curing the adhesive sheet to produce a laminate for evaluation.

Using a spectrophotometer (UV2000 manufactured by Shimadzu Corporation), a spectral transmittance (%) of the above-described laminate for evaluation at a wavelength of 300 nm to 800 nm was measured, and light transmittance at a wavelength of 380 nm and 400 nm was obtained.

### <Adhesive Force>

One mold release film of the adhesive sheet equipped with a mold release film produced in Examples and Comparative Examples was peeled off, and a polyethylene terephthalate film (“COSMOSHINE A4300” manufactured by Toyobo Co., Ltd.) having a thickness of 100 μm was bonded thereto as a backing film to prepare a laminated product.

The above-described laminated product was cut into a length of 150 mm and a width of 10 mm, the remaining mold release film was peeled off, the exposed adhesive surface was brought into contact with soda-lime glass, and the adhesive sheet was pressure-bonded by a roll reciprocated once. The obtained bonded product was aged at a temperature of 60° C. for 30 minutes to finish bonding, irradiated with light through the backing film using a 405 nm LED light source (FireJet FJ200 405 nm) with an integrated light amount of 3,000 mJ/cm² to cure the adhesive sheet, and aged at 23° C. for 15 hours, thereby obtaining a sample for measuring an adhesive force.

A peeling force (N/cm) with respect to glass when the sample for measuring an adhesive force was peeled off at a peeling angle of 1800 and a peeling rate of 60 mm/min in an environment of 23° C. and 40% RH was measured, and an adhesive force (P1) after the secondary curing was obtained.

TABLE 1

| | | | Example | Example | Comparative | Comparative | Comparative | Comparative |
|---|---|---|---|---|---|---|---|---|
| | | | A1 | A2 | Example A1 | Example A2 | Example A3 | Example A4 |
| Adhesive | (Meth)acrylic | A-1 | 100 | 100 | 100 | 100 | 100 | 100 |
| composition | polymer (A) | | | | | | | |
| (part by mass) | Photoinitiator (B) | b1-1 | 1.5 | 1.5 | | | | |
| | | b2-1 | | | 1.5 | | | |
| | | b2-2 | | | | 1.5 | | |
| | | b2-3 | | | | | 1.5 | |
| | | b2-4 | | | | | | 1.5 |
| | Polyfunctional | D-1 | | 1.5 | | | | 1.5 |
| | (meth)acrylate (D) | | | | | | | |

| | | | | | | | |
|---|---|---|---|---|---|---|---|
| Evaluation of | Gel fraction (X0) [%] | 34.0 | 43.7 | 0.0 | 0.0 | 2.5 | 32.5 |
| physical | Gel fraction (X1) [%] | 61.7 | 68.2 | 0.0 | 0.0 | 9.2 | 34.2 |
| properties | Difference (X1 − X0) [%] | 27.7 | 24.5 | 0.0 | 0.0 | 6.7 | 1.7 |
| | Chromaticity (b*0) | 0.9 | 0.9 | 0.4 | 0.4 | 1.5 | 0.7 |
| | Chromaticity (b*1) | 0.6 | 0.6 | 0.4 | 0.4 | 2.7 | 0.5 |
| | Difference (b*1 − b*0) | −0.3 | −0.3 | 0 | 0 | 1.2 | −0.2 |
| | Adhesive force (P1) | 8.6 | 8.9 | 12.1 (cohesion | 13.5 (cohesion | 10.5 (cohesion | 7.6 |

| | | |
|---|---|---|
| failure) | failure) | failure) |

The adhesive sheets of Examples A1 and A2 had sufficient curability with respect to the 405 nm LED light source, and the chromaticity (b*) was also within the reference value, which was a suitable result.

On the other hand, the adhesive sheets of Comparative Examples A1 and A2 deteriorated in curability with respect to the 405 nm LED light source. This is considered to be due to the fact that the molar absorption coefficient of the photoinitiator used at a wavelength of 405 nm was low.

The adhesive sheet of Comparative Example A3 was deteriorated in curability with respect to the 405 nm LED light source, and the chromaticity (b*) was also out of reference. It is considered that b* increased due to the characteristics of the photoinitiator.

Since the adhesive composition of Comparative Example A4 used a cleavage-type photoinitiator, a photodecomposition product was generated during the irradiation with active energy rays.

In addition, the adhesive sheet of Comparative Example A4 had insufficient active energy ray curability. This is because, since only the cleavage-type photoinitiator was used, it was difficult to control a state in which the photoinitiator was consumed by light irradiation during the production of the adhesive sheet and there was room for curing by active energy rays, and the photocurability of the adhesive sheet was lost.

### Example B1

100 parts by mass of the (meth)acrylic polymer (A-1), 1.5 parts by mass of the photoinitiator (b1-1), 1.4 parts by mass of the ultraviolet absorber (C-1), and 1.5 parts by mass of the polyfunctional (meth)acrylate (D-1) were uniformly mixed to produce an adhesive composition.

The above-described adhesive composition was developed in a sheet shape on a mold release film (PET film manufactured by Mitsubishi Chemical Corporation) having a thickness of 100 μm, which had been subjected to a silicone release treatment, such that the thickness was 100 μm.

Next, a silicone release-treated mold release film having a thickness of 75 μm (PET film manufactured by Mitsubishi Chemical Corporation) was laminated on the sheet-like adhesive composition to form a laminate, thereby obtaining an adhesive sheet equipped with a mold release film, consisting of a mold release film/adhesive sheet/mold release film.

Next, using a 405 nm LED light source (FireJet FJ200 405 nm), both surfaces of the adhesive sheet equipped with a mold release film were irradiated with light having a peak wavelength of 405 nm through the mold release film with an irradiation amount of 1,000 mJ/cm² (integrated light amount: 2,000 mJ/cm²) on both surfaces, and thus the adhesive sheet was semi-cured. The integrated light amount was measured using an ultraviolet light integrator “UIT-250” (manufactured by Ushio Inc.) and a light receiver “UVD-C₄₀₅” (manufactured by Ushio Inc.) (the same applies hereinafter).

The obtained adhesive sheet equipped with a mold release film included an adhesive sheet having active energy ray curability.

### Example B2

An adhesive sheet equipped with a mold release film was produced in the same manner as in Example B1, except that the formulation of the adhesive composition was changed as shown in Table 2.

### Example B3

100 parts by mass of the (meth)acrylic polymer (A-1), 1.5 parts by mass of the photoinitiator (b1-1), 1.2 parts by mass of the ultraviolet absorber (C-1), and 1.5 parts by mass of the polyfunctional (meth)acrylate (D-1) were uniformly mixed to produce an adhesive composition.

The above-described adhesive composition was developed in a sheet shape on a mold release film (PET film manufactured by Mitsubishi Chemical Corporation) having a thickness of 100 μm, which had been subjected to a silicone release treatment, such that the thickness was 100 μm.

Next, a silicone release-treated mold release film having a thickness of 75 μm (PET film manufactured by Mitsubishi Chemical Corporation) was laminated on the sheet-like adhesive composition to form a laminate, thereby obtaining an adhesive sheet equipped with a mold release film, consisting of a mold release film/adhesive sheet/mold release film.

Next, using a metal halide lamp, both surfaces of the adhesive sheet equipped with a mold release film were irradiated with light through the mold release film such that one surface was irradiated with an integrated light amount at a wavelength of 405 nm was 2,000 mJ/cm², and thus the adhesive sheet was semi-cured.

The obtained adhesive sheet equipped with a mold release film included an adhesive sheet having active energy ray curability.

### Examples B4 and B5

An adhesive sheet equipped with a mold release film was produced in the same manner as in Example B3, except that the formulation and light irradiation conditions of the adhesive composition were changed as shown in Table 2.

### Comparative Examples B1 to B3

An adhesive sheet equipped with a mold release film was produced in the same manner as in Example B1, except that the formulation of the adhesive composition was changed as shown in Table 2.

TABLE 2

| | | | Example | Example | Example | Example | Example | Comparative | Comparative | Comparative |
|---|---|---|---|---|---|---|---|---|---|---|
| | | | B1 | B2 | B3 | B4 | B5 | Example B1 | Example B2 | Example B3 |
| Adhesive | (Meth )acrylic | A-1 | 100 | | 100 | 100 | 100 | 100 | 100 | |
| composition | polymer (A) | A-2 | | 100 | | | | | | 100 |
| (part by | Photoinitiator (B) | b1-1 | 1.5 | 1.5 | 1.5 | 1.5 | 2.5 | | | |
| mass) | | b2-2 | | | | | | 1.5 | | |
| | | b2-3 | | | | | | | 1.5 | |
| | | b2-4 | | | | | | | | 2 |
| | Ultraviolet | C-1 | 1.4 | 1.4 | 1.2 | 1.2 | 1.2 | 1.4 | 1.4 | 1.4 |
| | absorber (C) | | | | | | | | | |
| | Polyfunctional | D-1 | 1.5 | | 1.5 | 1.5 | 1.5 | 1.5 | 1.5 | |
| | (meth)acrylate (D) | D-2 | | 10 | | | | | | |
| | | D-3 | | | | | | | | 10 |
| Light | Integrated light | mJ/cm² | 2000 | 2000 | 1000 | 2000 | 1000 | 2000 | 2000 | 2000 |
| irradiation | amount (405 nm) | | | | | | | | | |
| conditions | Light source lamp | — | LED | LED | Metal | Metal | Metal | LED | LED | LED |
| | | | | | halide | halide | halide | | | |
| Evaluation | Gel fraction | | 26.5 | 64.5 | 66.1 | 76.2 | 71.8 | 0.0 | 0.0 | 79.2 |
| of physical | (X0) [%] | | | | | | | | | |
| properties | Gel fraction | | 59.2 | 80.1 | 77.6 | 81.6 | 85.9 | 0.0 | 3.6 | 82.3 |
| | (X1) [%] | | | | | | | | | |
| | Difference | | 32.7 | 15.6 | 11.5 | 5.4 | 14.1 | 0.0 | 3.6 | 3.1 |
| | (X1 − X0) [%] | | | | | | | | | |
| | Chromaticity | | 1 | 1 | 1.1 | 1 | 1.3 | 0.8 | 2.2 | 1.1 |
| | (b*0) | | | | | | | | | |
| | Chromaticity | | 0.9 | 0.9 | 0.9 | 0.9 | 1.1 | 0.8 | 3.4 | 1.4 |
| | (b*1) | | | | | | | | | |
| | Difference | | −0.1 | −0.1 | −0.2 | −0.1 | −0.2 | 0 | 1.2 | 0.3 |
| | (b*1 − b*0) | | | | | | | | | |
| | Light | 380 nm | 2 | 2 | 1 | 1 | 1 | 2 | 2 | 2 |
| | transmittance [%] | 400 nm | 60 | 60 | 69 | 71 | 67 | 60 | 60 | 60 |

| | | | | | | | | |
|---|---|---|---|---|---|---|---|---|
| Adhesive force (P1) | 8.1 | 7.2 | 12.6 | 12.6 | 11.0 | 11.5 | 10.8 | 7.5 |
| | | | | | | (cohesion | (cohesion | |

| | |
|---|---|
| failure) | failure) |

The adhesive sheets of Examples B1 to B5 had sufficient curability with respect to the 405 nm LED light source, and the chromaticity (b*) was also within the reference value, which was a suitable result.

On the other hand, the adhesive sheets of Comparative Examples B1 and B2 deteriorated in curability with respect to the 405 nm LED light source. This is considered to be due to the fact that the molar absorption coefficient of the photoinitiator used at a wavelength of 405 nm was low.

Since the adhesive composition of Comparative Example B3 used a cleavage-type photoinitiator, a photodecomposition product was generated during the irradiation with active energy rays.

In addition, since the adhesive sheet of Comparative Example B3 was formulated with 10 parts by mass of the polyfunctional (meth)acrylate (D), the reaction of the polyfunctional (meth)acrylate (D) proceeded rapidly by light irradiation during the production of the adhesive sheet, the gel fraction (X0) was large, the difference (X1−X0) in the gel fraction was small, and thus the curing potential by active energy rays was reduced.

1. An adhesive composition comprising:
a (meth)acrylic polymer (A); and
a photoinitiator (B).

2. The adhesive composition according to claim 1, wherein the photoinitiator (B) includes a photoinitiator (b1) having a glyoxylate structure represented by Formula 1 and a molar absorption coefficient at a wavelength of 405 nm of 30 (L/mol·cm) or more, 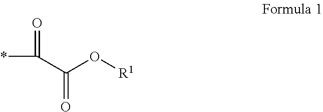
in Formula 1, R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl, and * represents a bonding site.

3. The adhesive composition according to claim 2, further comprising an ultraviolet absorber (C).

4. The adhesive composition according to claim 2,
wherein the photoinitiator (b1) comprises a compound having a biphenyl structure to which the bonding site * in Formula 1 is bonded.

5. The adhesive composition according to claim 2,
wherein the photoinitiator (b1) comprises a compound having a biphenyl sulfide structure to which the bonding site * in Formula 1 is bonded.

6. The adhesive composition according to claim 2,
wherein the photoinitiator (b1) comprises a compound having two or more radical-generating groups in a molecule.

7. The adhesive composition according to claim 2, further comprising:
a polyfunctional (meth)acrylate (D).

8. The adhesive composition according to claim 7,
wherein an amount of the polyfunctional (meth)acrylate (D) is 0.1 parts by mass or more and 20 parts by mass or less with respect to 100 parts by mass of the (meth)acrylic polymer (A).

9. The adhesive composition according to claim 2,
wherein the (meth)acrylic polymer (A) includes a constitutional unit derived from an alkyl (meth)acrylate containing a linear or branched alkyl group having 3 to 30 carbon atoms in an alkyl group, and includes a constitutional unit derived from a hydroxyl group-containing monomer and/or a constitutional unit derived from a nitrogen-containing monomer.

10. An adhesive sheet comprising:
an adhesive layer comprising the adhesive composition according to claim 2.

11. The adhesive sheet according to claim 10,
wherein light transmittance at a wavelength of 380 nm of the adhesive sheet is 10% or less.

12. The adhesive sheet according to claim 10,
wherein light transmittance at a wavelength of 400 nm of the adhesive sheet is 30% or less.

13. The adhesive sheet according to claim 10,
wherein total light transmittance of the adhesive sheet is 80% or more.

14. The adhesive sheet according to claim 10,
wherein a gel fraction (X0) of the adhesive sheet is 20% or more.

15. The adhesive sheet according to claim 14,
wherein the adhesive sheet has active energy ray curability, and
a gel fraction (X1) of the adhesive sheet when the adhesive sheet is irradiated with an active energy ray having a wavelength of 405 nm with an integrated light amount of 2,000 to 4,000 mJ/cm² is 30% or more.

16. The adhesive sheet according to claim 15,
wherein a difference (X1−X0) between the gel fraction (X1) and the gel fraction (X0) is 2% or more.

17. The adhesive sheet according to claim 10,
wherein the adhesive sheet has active energy ray curability,
a chromaticity (b*1) of the adhesive sheet when the adhesive sheet is irradiated with an active energy ray having a wavelength of 405 nm with an integrated light amount of 2,000 to 4,000 mJ/cm² is 2.5 or less, and
a difference (b*1−b*0) between the chromaticity (b*1) and a chromaticity (b*0) before the irradiation with the active energy ray is 1.0 or less.

18. The adhesive sheet according to claim 10,
wherein the adhesive sheet is used for bonding an optical member.

19. An adhesive sheet equipped with a mold release film, comprising:
the adhesive sheet according to claim 10; and
a mold release film which is laminated with the adhesive sheet.

20. A laminate for image display devices, comprising:
two optical members which are laminated through the adhesive sheet according to claim 10.

21. An image display device, comprising:
the laminate for image display devices according to claim 20.

22. An adhesive sheet for organic EL display devices, comprising:
the adhesive sheet according to claim 10.

23. The adhesive sheet according to claim 1,
wherein the photoinitiator (B) includes a compound represented by Formula 2, 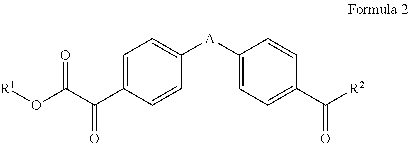
in Formula 2, A is O, S, NR⁴, or a linear or branched alkylene or cycloalkylene having 1 to 6 carbon atoms,
R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl,
R² is a hydrogen atom, a substituted or unsubstituted C₁ to C₂₀ alkyl, a substituted or unsubstituted C₃ to C₂₀ cycloalkyl, a substituted or unsubstituted C₂ to C₂₀ heterocycloalkyl, a substituted or unsubstituted C₆ to C₂₀ aryl, a substituted or unsubstituted C₁ to C₂₀ heteroaryl, SR⁵, OR⁶, NR⁷R⁸, C(O)R⁹, or C(O)OR¹³,
R⁴ is a group selected from the group consisting of a hydrogen atom, a C₁ to C₁₈ alkyl, a C₂ to C₁₈ alkanoyl, a C₆ to C₁₀ aryl, and a C₇ to C₁₁ aroyl,
R⁵ and R⁶ are each independently a group selected from the group consisting of a hydrogen atom, a C₁ to C₂₀ alkyl, a C₂ to C₂₀ alkanoyl, a C₆ to C₁₀ aryl, and a C₇ to C₁₁ aroyl,
R⁷ and R⁸ are each independently a group selected from the group consisting of a hydrogen atom, a C₁ to C₂₀ alkyl, a C₂ to C₂₀ alkanoyl, a C₇ to C₁₁ aroyl, and a C₆ to C₁₀ aryl,
R⁹ is a group selected from the group consisting of a hydrogen atom, a C₁ to C₂₀ alkyl, and a C₆ to C₂₀ aryl, and
R¹³ has the same definition as that for R¹.

24. The adhesive sheet according to claim 3,
wherein the photoinitiator (B) includes a compound represented by Formula 2, 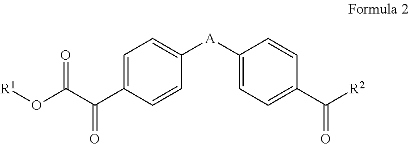
in Formula 2, A is O, S, NR⁴, or a linear or branched alkylene or cycloalkylene having 1 to 6 carbon atoms,
R¹ is a substituted or unsubstituted C₁ to C₂₀ alkyl, a substituted or unsubstituted C₃ to C₂₀ cycloalkyl, or a substituted or unsubstituted C₂ to C₂₀ heterocycloalkyl,
R² is a hydrogen atom, a substituted or unsubstituted C₁ to C₂₀ alkyl, a substituted or unsubstituted C₃ to C₂₀ cycloalkyl, a substituted or unsubstituted C₂ to C₂₀ heterocycloalkyl, a substituted or unsubstituted C₆ to C₂₀ aryl, a substituted or unsubstituted C₁ to C₂₀ heteroaryl, SR⁵, OR⁶, NR⁷R⁸, C(O)R⁹, or C(O)OR¹³,
R⁴ is a group selected from the group consisting of a hydrogen atom, a C₁ to C₁₈ alkyl, a C₂ to C₁₈ alkanoyl, a C₆ to C₁₀ aryl, and a C₇ to C₁₁ aroyl,
R⁵ and R⁶ are each independently a group selected from the group consisting of a hydrogen atom, a C₁ to C₂₀ alkyl, a C₂ to C₂₀ alkanoyl, a C₆ to C₁₀ aryl, and a C₇ to C₁₁ aroyl,
R⁷ and R⁸ are each independently a group selected from the group consisting of a hydrogen atom, a C₁ to C₂₀ alkyl, a C₂ to C₂₀ alkanoyl, a C₇ to C₁₁ aroyl, and a C₆ to C₁₀ aryl,
R⁹ is a group selected from the group consisting of a hydrogen atom, a C₁ to C₂₀ alkyl, and a C₆ to C₂₀ aryl, and
R¹³ has the same definition as that for R¹.
